(19) United States
(12) Patent Application Publication
(10) Pub. No.: US 2011/0217994 A1
(43) Pub. Date: Sep. 8, 2011

(54) Systems and Methods to Automate Transactions via Mobile Devices

(75) Inventors: Ron HIRSON, San Francisco, CA (US); Erich L. RINGEWALD, Belvedere, CA (US); David YOO, San Mateo, CA (US)

(73) Assignee: BOKU, INC., San Francisco, CA (US)

(21) Appl. No.: 12/772,937

(22) Filed: May 3, 2010

Related U.S. Application Data
(60) Provisional application No. 61/310,209, filed on Mar. 3, 2010.

(51) Int. Cl. H04W 4/12; G06Q 30/00; G06Q 50/00; H04L 9/30

(52) U.S. Cl. 455/466; 705/71; 705/27.1

(57) ABSTRACT

Systems and methods are provided to automate transactions via mobile communications. In one aspect, a system includes a data storage facility to store data associating phone numbers with accounts and an interchange coupled with the data storage facility. The interchange includes a common format processor and a plurality of converters to interface with a plurality of different controllers of mobile communications. The converters are configured to communicate with the controllers in different formats and with the common format processor in a common format. The common format processor has an application programming interface to receive requests, such as a charge request having an identification of a phone number, an identification of a merchant, and an amount, and a status request having an identification of the first request, and is to transmit a message to a telephonic apparatus at the phone number to confirm the charge request, using one of the converters.

The present application claims priority to provisional U.S. Patent Application Ser. No. 61/310,209, filed Mar. 3, 2010 and entitled “Systems and Methods to Automate Transactions via Mobile Devices,” the disclosure of which is incorporated herein by reference.

### FIELD OF THE TECHNOLOGY

At least some embodiments of the disclosure relate to mobile communications in general and, more particularly but not limited to, mobile communications to facilitate online transactions.

### BACKGROUND

Short Message Service (SMS) is a communications protocol that allows the interchange of short text messages between mobile telephone devices. SMS messages are typically sent via a Short Message Service Center (SMSC) of a mobile carrier, which uses a store-and-forward mechanism to deliver the messages. When a mobile telephone is not reachable immediately for the delivery of the message, the SMSC stores the message for later retry.

SMS messages can be sent via gateways. Some gateways function as aggregators. An aggregator typically does not have the capacity to deliver the messages directly to the mobile phones. An aggregator typically interfaces with and relies upon the SMSC of a mobile carrier to deliver SMS messages.

Some gateways function as providers that are capable of sending text messages to mobile devices directly, without going through the SMSC of other mobile operators.

Text messaging between mobile telephones can also be performed using other protocols, such as SkyMail and Short Mail in Japan.

Some mobile carriers provide email gateway services to allow text messages to be sent to mobile phones via email. For example, a non-subscriber of the mobile carrier may send a message to an email address associated with a mobile phone of a subscriber of the mobile carrier to have the message delivered to the mobile phone via text messaging.

Emails can also be sent to mobile telephone devices via standard mail protocols, such as Simple Mail Transfer Protocol (SMTP) over Internet Protocol Suite (commonly TCP/IP, named from two of the protocols: the Transmission Control Protocol (TCP) and the Internet Protocol (IP)).

Short messages may be used to provide premium services to mobile phones, such as news alerts, ring tones, etc. The premium content providers may send the messages to the SMSC of the mobile operator using a TCP/IP protocol, such as Short Message Peer-to-peer Protocol (SMPP) or Hypertext Transfer Protocol, for delivery to a mobile phone; and the mobile phone is billed by the mobile operator for the cost of receiving the premium content.

Premium services may also be delivered via text messages initiated from the mobile phone. For example, a televoting service provider may obtain a short code to receive text messages from mobile phones; and when the user sends a text message to the short code, the mobile carrier routes the message to the televoting service provider and charges the user a fee, a portion of which is collected for the televoting service provider.

### SUMMARY OF THE DESCRIPTION

Systems and methods are provided to facilitate online transactions via mobile communications. Some embodiments are summarized in this section.

In one aspect, a system includes a data storage facility to store data associating phone numbers with accounts and an interchange coupled with the data storage facility. The interchange includes a common format processor and a plurality of converters to interface with a plurality of different controllers of mobile communications. The converters are configured to communicate with the controllers in different formats; and the converters are configured to communicate with the common format processor in a common format.

In one embodiment, the common format processor is the common format processor configured with an application programming interface to receive requests via Hypertext Transfer Protocol, the requests including a first request having an identification of a phone number, an identification of a merchant, and an amount, and a second request having an identification of the first request. The common format processor is to use one converter of the converters to transmit a message to a telephonic apparatus at the phone number to confirm the first request. After the first request is confirmed via communicating with the telephonic apparatus at the phone number, the common format processor is to charge the user of the phone number according to the amount specified in the first request. The common format processor is to provide a status of the first request in response to the second request, in accordance with the application programming interface.

In another aspect, a method includes: providing a computing device configured with an application programming interface; receiving requests using the computing device through the application programming interface, the requests including a first request having an identification of a phone number, an identification of a merchant and an amount, and a second request having an identification of the first request; transmitting a message from the computing device to a telephonic apparatus at the phone number to confirm the first request; after the first request is confirmed via communicating with the telephonic apparatus at the phone number, charging the user of the phone number according to the amount specified in the first request; and providing a status of the first request in response to the second request, in accordance with the application programming interface.

In a further aspect, a method includes: providing a software development kit to a developer of a mobile application, the software development kit including a set of instructions to be included as part of the mobile application, when executed on a mobile phone the set of instructions to cause the mobile phone to: identify a Mobile Subscriber Integrated Services Digital Network Number (MSISDN) of the mobile phone, communicate with a remote server to determine a set of discrete price points supported by a mobile carrier of the mobile phone, provide the set of discrete price points to the mobile application, receive a charge request based on the set of discrete price points from the mobile application in accordance with an application programming interface provided by the software development kit, communicate the charge request to the remote server, monitor an inbox of the mobile phone for a message from the remote server indicating a success in fulfilling the charge request, and notify the mobile application of the success in accordance with the application programming interface.

The disclosure includes methods and apparatuses which perform these methods, including data processing systems which perform these methods, and computer readable media containing instructions which when executed on data processing systems cause the systems to perform these methods.

Other features will be apparent from the accompanying drawings and from the detailed description which follows.

### BRIEF DESCRIPTION OF THE DRAWINGS

The embodiments are illustrated by way of example and not limitation in the figures of the accompanying drawings in which like references indicate similar elements.

FIG. 1 shows a system to facilitate online transactions according to one embodiment.

FIG. 2 shows an interchange to route messages according to one embodiment.

FIG. 3 shows a message processor according to one embodiment.

FIG. 4 shows a method to facilitate an online transaction using an interchange according to one embodiment.

FIG. 5 illustrates a user interface to associate an account with a telephone number according to one embodiment.

FIG. 6 illustrates another user interface to associate an account with a telephone number according to one embodiment.

FIG. 7 illustrates a user interface to initiate a payment transaction according to one embodiment.

FIG. 8 illustrates a user interface to initiate a payment request according to one embodiment.

FIG. 9 illustrates a user interface to confirm a payment request according to one embodiment.

FIG. 10 illustrates a user interface to confirm the completion of a payment transaction according to one embodiment.

FIG. 11 illustrates a way to redirect a payment confirmation according to one embodiment.

FIG. 12 illustrates a user interface to receive payment options according to one embodiment.

FIG. 13 shows a method to process an online payment according to one embodiment.

FIG. 14 shows another method to facilitate a payment transaction according to one embodiment.

FIG. 15 illustrates a user interface to confirm a transaction according to one embodiment.

FIG. 16 illustrates a mobile phone configured to confirm transactions according to one embodiment.

FIGS. 17-19 illustrate methods to confirm transactions according to one embodiment.

FIG. 20 illustrates an application programming interface (API) according to one embodiment.

FIG. 21 illustrates a software development kit (SDK) according to one embodiment.

FIG. 22 illustrates a method to process transaction requests according to one embodiment.

FIG. 23 illustrates a method to process transaction requests in mobile applications according to one embodiment.

FIG. 24 illustrates an SDK according to one embodiment.

FIGS. 25-27 illustrate a mobile application using an SDK according to one embodiment.

FIG. 28 illustrates a method performed in an SDK according to one embodiment.

FIG. 29 shows a data processing system, which can be used in various embodiments.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In one embodiment, an interchange is used to interface with a plurality of different controllers of mobile communications, such as SMS messages. The interchange can be used to associate account information with phone numbers to facilitate electronic payments via mobile devices, such as cellular phones. The interchange is configured to communicate with the mobile phones through the different controllers to provide security and convenience for online transactions.

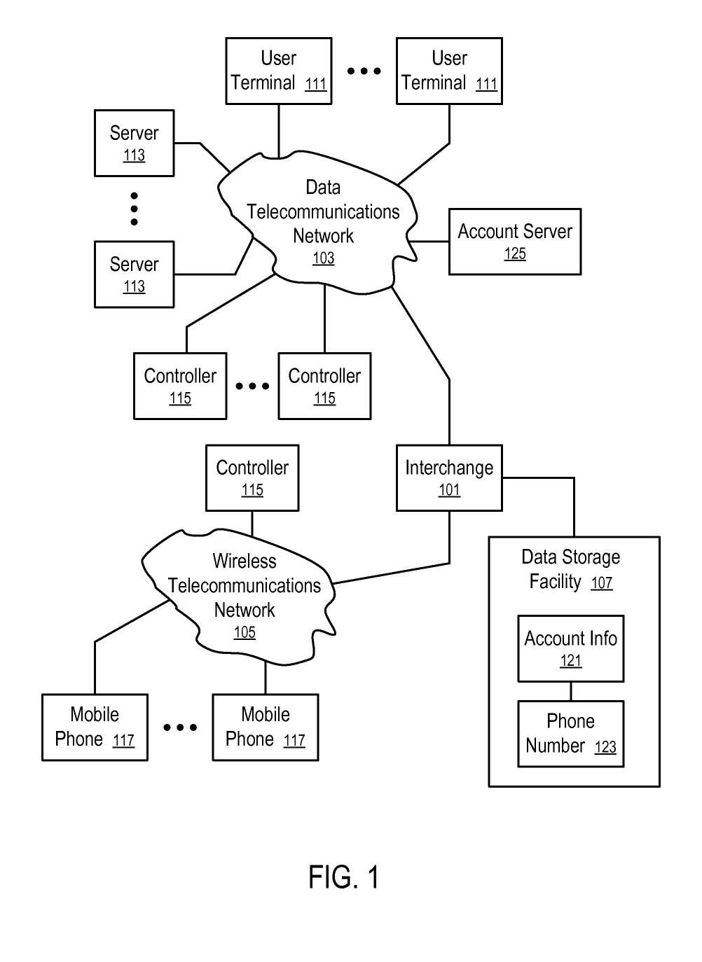

FIG. 1 shows a system to facilitate online transactions according to one embodiment. In FIG. 1, an interchange (101) is provided to interface with a plurality of different controllers (115) for communications with the mobile phones (117) over the wireless telecommunications network (105).

In FIG. 1, a data storage facility (107) stores user account information (121) and the corresponding phone numbers (123) of the mobile phones (117). The interchange (101) is coupled with the data storage facility (107) to communicate with the mobile phones (117) at the corresponding phone numbers (123) to confirm operations that are performed using the account information (121). Since the account information (121) is secured by the interchange (101), the account information (121) can be used to pay for products and services offered by the servers (113) of various merchants, without being revealed to the merchants.

In one embodiment, the server (113) offers products and/or services adapted for a virtual world environment, such as an online game environment, a virtual reality environment, etc. The products may be virtual goods, which can be delivered via the transmission of data or information (without having to physically deliver an object to the user). For example, the virtual goods may be a song, a piece of music, a video clip, an article, a computer program, a decorative item for an avatar, a piece of virtual land in a virtual world, a virtual object in a virtual reality world, etc. For example, an online game environment hosted on a server (113) may sell services and products via points or virtual currency, which may be consumed by the user while engaging in a game session. For example, a virtual reality world hosted on a server (113) may have a virtual currency, which may be used by the residents of the virtual reality world to conduct virtual commerce within the virtual reality world (e.g., buy virtual lands, virtual stocks, virtual objects, services provided in the virtual reality world, etc). In other embodiments, the server (113) may also offer physical goods, such as books, compact discs, photo prints, postcards, etc.

In FIG. 1, the interchange (101) may communicate with different controllers (115) of mobile communications via different networks (e.g., 105 and 103) and/or protocols. The interchange (101) processes the requests in a common format and uses a set of converters for communications with the different controllers (115) respectively.

For example, the controllers (115) may be different aggregators, providers and/or SMSCs of different mobile carriers. Based on the phone numbers (123), the interchange (101) interfaces with the corresponding controllers (115) to communicate with the mobile phones (117) via text messaging to confirm the operations related to the corresponding account information (121), such as bank accounts, credit card numbers, charge card numbers, etc.

In FIG. 1, the user terminals (111) may use a unified interface to send requests to the interchange (101). For example, a website of the interchange (101) may be used to receive the account information (121) from the web browsers running in the user terminals (111). The user terminals (111) are typically different from the mobile phones (117). However, in some embodiments, users may use the mobile phone (117) to access the web and submit the account information (121). Alternatively, the users may use the mobile phone (117) to submit the account information (121) to the interchange (101) via text messaging, email, instant messaging, etc.

The use of the mobile phones (117) in the confirmation of activities that involve the account information (121) increases the security of the transaction, since the mobile phones (117) are typically secured in the possession of the users.

Further, in one embodiment, the interchange (101) may use the phone bills of the mobile phones (117) to pay for purchases, in order to use the account information (121) to pay for the phone bills, and/or to deposit funds into the accounts identified by the account information (121) by charging on the phone bills of the corresponding mobile phones (117). In some embodiments, the accounts identified by the account information (121) are hosted on the data storage facility (107). In other embodiments, the accounts are hosted on the account servers (125) of financial institutions, such as banks, credit unions, credit card companies, etc.

In one embodiment, once the account information (121) is associated with the mobile phones (117) via their phone numbers (123) stored in the data storage facility (107), the users may use the user terminals (111) to access online servers (113) of various merchants or service providers to make purchases. From the user terminals (111), the users can use the accounts identified by the account information (121) to make the payment for the purchases, without revealing their account information (121) to the operators of the servers (113).

In one embodiment, the mobile phones (117) are used by the corresponding users to make payments and/or manage funds, such as for making purchases in various websites hosted on the servers (113) of merchants and service providers and/or for transferring funds to or from an account identified by the account information (121), such as phone bills of land-line telephone services, credit card accounts, debit card accounts, bank accounts, etc., or an account hosted on the data storage facility (107) or telecommunication accounts of the mobile phones (117) with telecommunication carriers. The mobile phones (117) are used to confirm and/or approve the transactions associated with the account identified by the account information (121) (or other accounts). The interchange (101) interfaces the mobile phones (117) and the servers (113) to confirm and/or approve transactions and to operate on the account identified by the account information (121) (and/or other accounts associated with the phone number (123)).

For example, the user terminal (111) may provide the phone numbers (123) to the servers (113) to allow the servers (113) to charge the account identified by the account information (121) associated with the phone number (123). The interchange (101) sends a message to the mobile phone (117) via the phone number (123) to confirm the payment request. Once the payment is confirmed or approved via the corresponding mobile phone (117), the interchange (101) charges the account identified by the account information (121) (e.g., by communicating with the account server (125) on which the corresponding accounts are hosted) and pays the server (113) on behalf of the user, using the funds obtained from the corresponding account identified by the account information (121).

In one embodiment, the user terminal (111) may not even provide the phone number (123) to the server (113) to process the payment. The server (113) may redirect a payment request to the interchange (101), which then prompts the user terminal (111) to provide the phone number (123) to the website of the interchange (101) to continue the payment process.

For example, the server (113) may redirect the payment request to the website of the interchange (101) with a reference indicating the purchase made via the user terminal (111). The interchange (101) can use the reference to subsequently complete the payment with the server (113) for the purchase, after receiving the phone number (123) directly from the user terminal (111) to confirm the payment via the mobile phone (117).

In some embodiments, instead of directly providing the phone number (123) to identify the account information (121), the user may provide other information to identify the phone number (123), such as an account identifier of the user assigned to the user for obtaining the services of the interchange (101).

In one embodiment, the account information (121) is pre-associated with the phone number (123) prior to the payment request. The account information (121) may be submitted to the interchange (101) via the user terminal (111) or the mobile phone (117) via a secure connection.

Alternatively, the user may supply the account information (121) to the interchange (101) at the time the payment request is submitted from the user terminal (111) to the interchange (101). Alternatively, the user may supply the account information (121) to the interchange (101) at the time the user responds to the confirmation message for the payment request.

In some embodiments, the user may supply the account information (121) after a transaction using funds collected via the telecommunication carrier of the mobile phone (117) at the phone number (123). For example, after the transaction, the interchange (101) may send an invitation message, such as a text message to the mobile phone (117) at the phone number (123), to the user to invite the user to register with the interchange (101) and provide the account information (121). The user may register with the interchange (101) via the mobile phone (117) (e.g., by a replying text message), or via a web page of the interchange (101) (e.g., using a link and/or a unique code provided in the invitation message).

After the user registers with the interchange (101) (e.g., via the mobile phone (117) and by providing the account information (121)), the user may create a customized personal identification number (PIN) or receive a PIN for enhanced security. Using the PIN, the user may use the account information (121) to complete an online transaction without having to confirm and/or approve a transaction using the mobile phone (117). In some embodiments, the PIN may be used to reduce unwanted messages to the mobile phone (117). For example, once the phone number (123) and the account information (121) are associated with a PIN, the interchange (101) may require the user of the user terminal (111) to provide the correct PIN to initiate the payment process. Thus, a spammer having only the phone number (123) (or a different user mistakenly using the phone number (123)) may not successfully use the user terminal (111) to request the interchange (101) to send confirmation messages to the mobile phone (117) protected by the PIN. In some embodiments, the interchange (101) may offer further incentives to the user for registering with the interchange (101), such as reduced fees, discounts, coupons, free products and services, etc.

In one embodiment, once the account information (121) is associated with the phone number (123) in the data storage facility (107), the user does not have to resubmit the account information (121) in subsequent payment requests.

By delegating the payment task to the interchange (101) and securing the account information (121) in the data storage facility (107), the system as shown in FIG. 1 can increase the security of using the account information (121) in an online environment.

In some embodiments, the interchange (101) can also fulfill the payment requests using the funds collected via the phone bill of the phone numbers (123). The interchange (101) can collect the funds via sending premium messages to the mobile phones (117) at the phone numbers (123), after receiving confirmation from the mobile phone (117).

For example, after the confirmation or approval message is received from the mobile phone (117), the interchange (101) performs operations to collect funds via the phone bill of the phone number (123). The interchange (101) may calculate the required premium messages to bill to the mobile phone (117). For example, mobile terminated premium SMS messages may have a predetermined set of prices for premium messages. The interchange (101) determines a combination of the premium messages that has a price closest to the amount required by the transaction, and sends this combination of premium messages to the mobile phone (117). For example, mobile originated premium SMS messages may also have a predetermined set of prices for premium messages. The interchange (101) can calculate the set of messages required for the transaction and transmit a text message to the mobile phone (117) of the user to instruct the user to send the required number of premium messages to provide the funds.

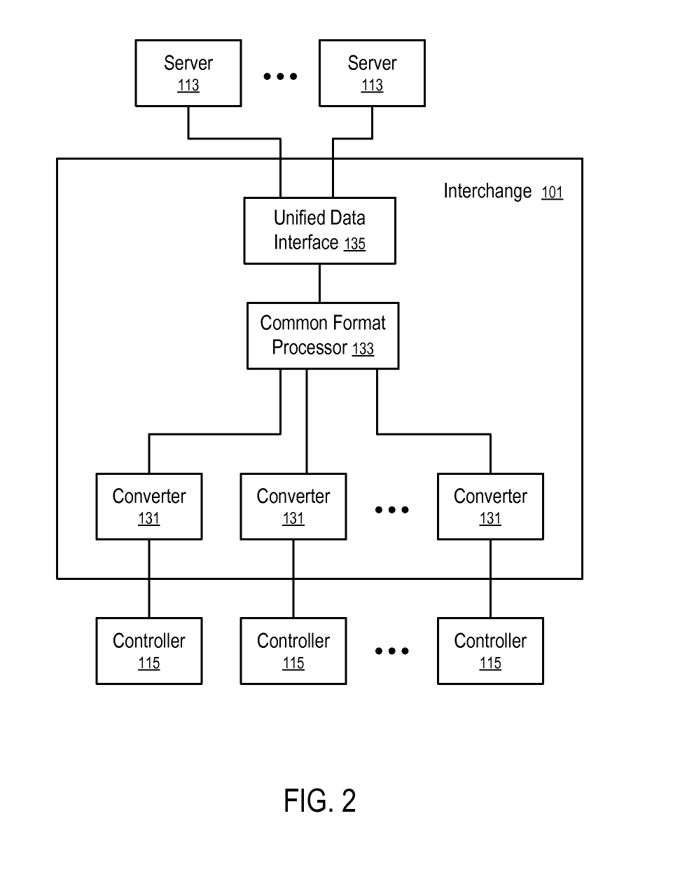

FIG. 2 shows an interchange to route messages according to one embodiment. In FIG. 2, the interchange (101) includes a unified data interface (135) for interaction with the servers (113). The servers (113) may redirect the payment requests to the interchange (101) to allow the interchange (101) to subsequently communicate with the user to process the payment request, including obtaining payment options and identifying user accounts (123), before returning to communicating with the server (113). Alternatively, the servers (113) may collect account related information (e.g., the phone number of the user) to request payment from the interchange (101).

In FIG. 2, the interchange (101) includes a common format processor (133), which processes various payment options in a common format. In one embodiment, the common format processor (133) can handle the payments via mobile terminated text message, mobile originated text message, operator bill, credit card, stored value account, and other online payment options. The common format processor (133) determines the actual amount that is to be billed to the user, based on the payment options (e.g., mobile terminated premium SMS, mobile originated premium SMS, operator billing, credit cards, etc.), and selects a converter (131) to communicate with a corresponding controller (115).

Different converters (131) are configured to communicate with corresponding controllers (115) in different languages and protocols. The converters (131) perform the translation between the common format used by the common format processor (133) and the corresponding formats used by the controllers (115).

The use of the common format processor (133) simplifies the structure of the interchange (101) and reduces the development effort required for the interchange (101) to interface with the increasing number of different controllers, such as SMSC, mobile providers, aggregators, gateways, etc.

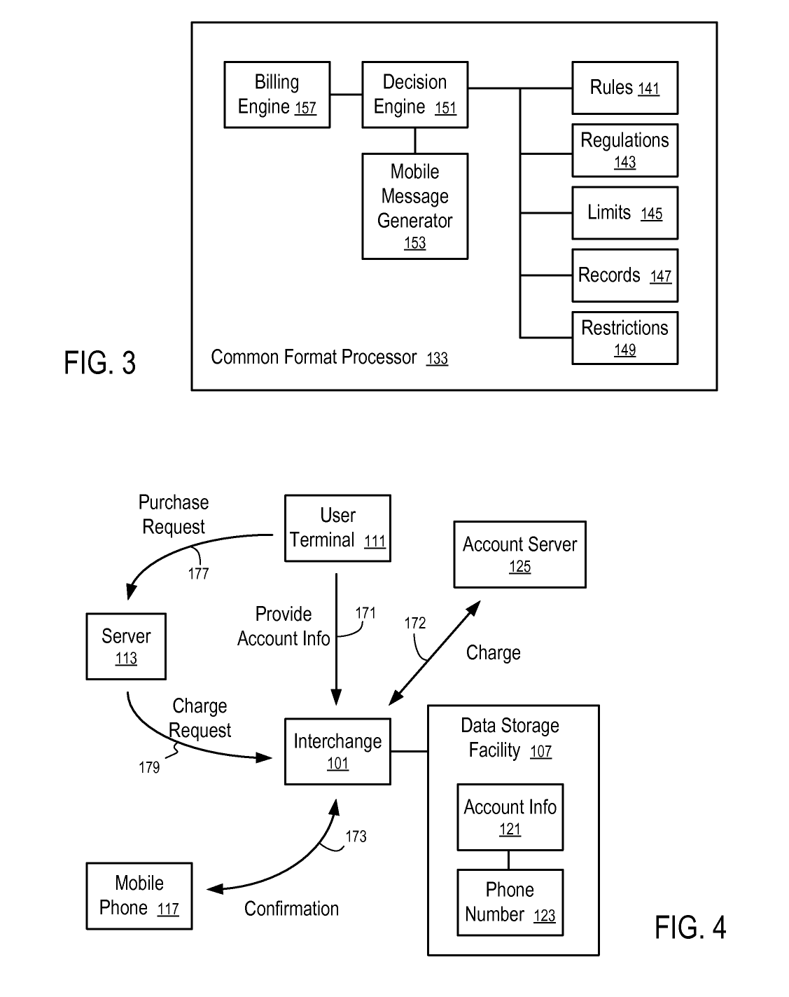

FIG. 3 shows a message processor according to one embodiment. In FIG. 3, the common format processor (133) includes a billing engine (157) that calculates the amount to be billed to the user, by adding or subtracting transaction costs for different billing methods, such as mobile terminated text message, mobile originated text message, operator billing, credit card, stored value account, and other online payment options.

In one premium message billing method, the interchange (101) sends mobile terminated premium SMS messages to the mobile phone (117) to bill the user, or requests the mobile phone (117) to send mobile originated premium SMS messages to a short code representing the interchange (101).

In one operator billing method, the interchange (101) directly sends a message to the mobile carrier of the mobile phone (117) to bill the amount on the phone bill of the mobile phone (117), without having to send a premium message to the mobile phone (117).

The common format processor (133) includes a decision engine (151) which decides how to generate a set of one or more messages to the mobile phone (117) based on a set of rules (141), regulations (143), limits (145), records (147) and restrictions (149).

For example, different countries have different regulations (143) governing the mobile communications with the mobile phones (117). For example, different mobile carriers have different rules (141) regarding premium messages. For example, past transaction records (147) can be used to monitor the transactions to discover suspected fraudulent activities. For example, parental limits (145) and merchant restrictions (149) can be imposed.

Based on results of the decision engine (151), the mobile message generator (153) generates one or more messages to communicate with the mobile phone (117) about the transaction (e.g., a request to collect funds via the phone bill of the user for a payment request, or for deposit into an account identified by the account information (121)). The converter (131) then interfaces with the corresponding controller (115) to transmit the messages to the mobile phones (117).

FIG. 4 shows a method to facilitate an online transaction using an interchange according to one embodiment. In FIG. 4, the user terminal (111) provides (171) account information (121) to the interchange (101) for association with the phone number (123). For example, the user may use a device running a web browser as the user terminal (111) to submit the account information (121) via a secure web connection. The user terminal (111) is typically different from the mobile phone (117). However, in some embodiments, the mobile phone (117) may also be used as the user terminal (111) to submit the account information (121) (e.g., via a wireless application protocol (WAP) application, or via a message sent via short message service (SMS) or multimedia message service (MMS), or via an email message or an instant message).

After the user provides the account information (121) to the interchange (101) for storage in the data storage facility (107), the user can send (177) a charge request to the server (113) of a merchant from the user terminal (111). The server (113) of the merchant can send or redirect (179) the charge request to the interchange (101). In response to the charge request, the interchange (101) sends (173) a confirmation message to the mobile phone (117). If the user sends (173) an approval, or an appropriate reply, to the confirmation message from the mobile phone (117), the interchange (101) communicates with the account server (125) to charge an account of the user identified by the account information (121), without revealing the account information (121) to the server (113). The interchange (101) pays the merchant on behalf of the user using the funds collected via charging the account of the user. For example, the interchange (101) may use its own bank account to pay the merchant operating the server (113). Thus, the financial information of the user is not revealed to the merchant.

Upon the completion of the payment process, the interchange (101) can notify the user via the mobile phone (117) and/or the user terminal (111).

In some embodiments, the server (113) of the merchant redirects the charge request to allow the user terminal (111) to communicate with the interchange (101) to continue the payment process; and the user terminal (111) may provide (171) the account information (121) directly to the interchange (101) after the charge request is redirected.

In alternative embodiments, the user may provide the account information (121) from the mobile phone (117) together with the approval of the charge request.

In one embodiment, the interchange (101) communicates with the mobile phone (117) for the confirmation of the charge request via SMS messages. Alternatively, the confirmation and approval messages can be sent (173) via emails, instant messages, voice message, live calls from operators, etc.

In some embodiments, the user of the mobile phone (117) may choose to fulfill the charge request via the phone bill, instead of charging the account identified by the account information (121). Thus, after the confirmation, the interchange (101) sends the premium messages to the mobile phone (117) to collect funds via the phone bill of the mobile phone (117). In other embodiments, the interchange (101) may send an instruction with the confirmation message to the mobile phone (117) to instruct the user to send mobile originated premium messages to the interchange (101) to collect the funds via the phone bill of the mobile phone (117).

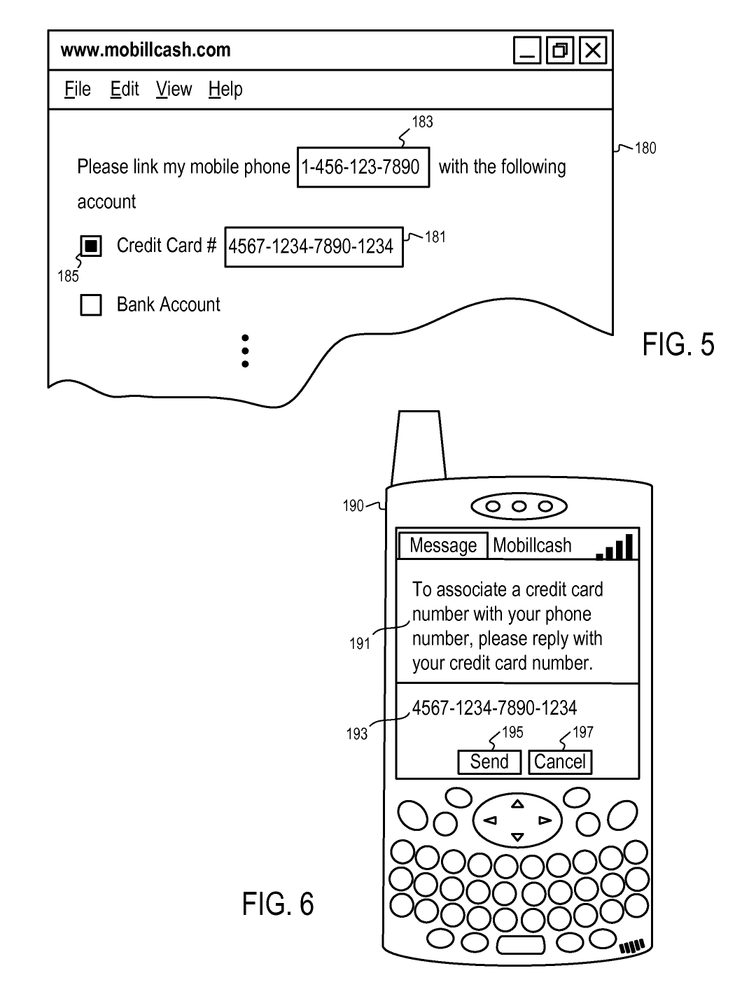

FIG. 5 illustrates a user interface to associate an account with a telephone number according to one embodiment. In FIG. 5, the user interface (180) includes a text field (183) that allows the user to specify the phone number (123) with which the account information (121) provided in the text field (181) is to be associated.

In FIG. 5, the user interface (180) further includes an option list, which allows the user to select various types of accounts, such as credit card accounts, bank accounts, charge card accounts, etc. In the example illustrated in FIG. 5, the checkbox (185) is selected to specify a credit card account.

In some embodiments, the user interface (180) may further present a text field (not shown in FIG. 5) to allow the user to specify an alias for the account information (121) supplied in the text input field (181). For enhanced security, the alias can be used for subsequent communications with the user without revealing the account information (121).

In FIG. 5, the user interface (180) may be presented via a web browser (or a custom application) to submit account information (121) in the text input field (181) from a user terminal (111) to the interchange (101). Alternatively, the account number can be submitted from the mobile phone (117) via a message sent via SMS, WAP, voice mail, or via an interactive voice response (IVR) system.

FIG. 6 illustrates another user interface to associate an account with a telephone number according to one embodiment. In FIG. 6, the user interface (190) is presented on the mobile phone (117) of the user. The user interface (190) presents a message (191) from the interchange (101) to the mobile phone (117) at the phone number (123). The message (191) prompts the user to submit the account information (121) by providing a reply message (193). The user may select the “send” button (195) to provide the account information (121) for association with the phone number (123) or select the “cancel” button (197) to ignore the prompt.

In one embodiment, the messages (191 and 193) are transmitted to the mobile phone (117) via a short message service (SMS). Alternatively, the messages can be transmitted to the mobile phone (117) via other protocols, such as multimedia message service (MMS), email, instant messaging, WAP, voice mail, voice messages via an interactive voice response (IVR) system, etc.

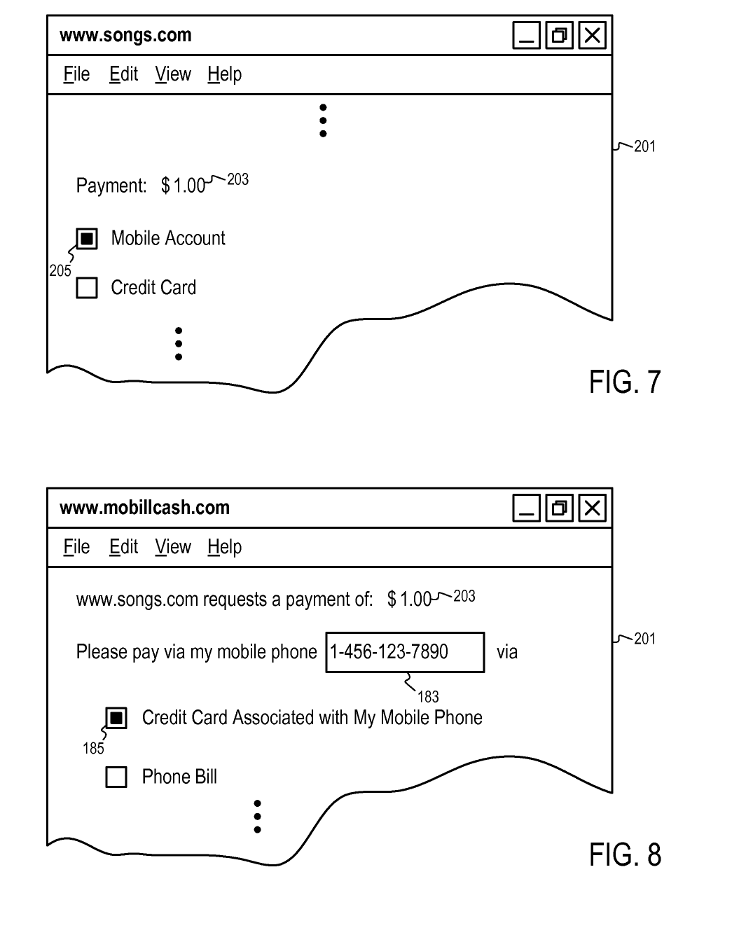

FIG. 7 illustrates a user interface to initiate a payment transaction according to one embodiment. In FIG. 7, the user interface (201) provides an option (205) to request the interchange (101) to process the payment for the amount (203) required to make a purchase from the server (113) of a merchant.

In one embodiment, after the user selects the payment option (205), the server (113) directs the request to the web server of the interchange (101), with a set of parameters to indicate the amount (203), the identity of the merchant, a reference to the purchase, etc. Thus, the user does not have to provide any personal information to the server (113) of the merchant to complete the payment process.

Alternatively, the user may provide the phone number to the merchant to process the payment. Thus, the user does not have to visit the website of the interchange (101) to complete the payment.

In one embodiment, the server (113) presents the payment option (205) via an online shopping cart system or a third party checkout system. Alternatively or in combination, the server (113) presents the payment option (205) via a web widget. For example, a web widget may include a program code that is portable and executable within a web page without requiring additional compilation. The web widget allows the user to select the option (205) to pay for the product and/or service without leaving the web page or refreshing the web page. In one embodiment, the interchange (101) provides the web widget to facilitate the payment processing.

FIG. 8 illustrates a user interface to initiate a payment request according to one embodiment, after the payment request is redirected to the website of the interchange (101). In FIG. 8, the user interface (201) includes the identity of the merchant and the amount (203) of the requested payment. The user interface (201) includes a text field (183) to allow the user to provide the phone number (123) to identify the account information (121) via its association with the phone number (123) in the data storage facility (107).

Further, user authentication may be used to reduce false messages to the phone number (123). For example, the user interface (201) may request a PIN for enhanced security. For example, the user may be required to register with the interchange (101) prior to using the services of the interchange (101); and after registering with the interchange (101), the user is provided with the PIN or can created a customized PIN to access the functionality provided by the user interface (201).

Alternatively, the user interface (201) may request an identifier associated with the phone number (123) to initiate the payment transaction. In some embodiments, the user interface (201) requires the user to provide no information other than the phone number (123) in the text field (183) to initiate the transaction.

In FIG. 8, the user interface (201) allows the user to select one option from a plurality of payment options, including paying via the phone bill, and paying via one or more of the accounts identified by the account information (121) associated with the phone number (123) in the data storage facility (107).

In some embodiments, the user interface (201) may present the payment options after authenticating the user (e.g., via a personal identification number or password) for enhanced security.

In some embodiments, the user interface (201) identifies the different accounts represented by the account information (121) by showing aliases of the accounts. The aliases may be previously specified by the user, or be dynamically generated by the interchange (101) based on the types of the accounts and/or portions of the account information (121) (e.g., the first or last few digits of the account number, etc.)

In one embodiment, once the user submits the payment request via the user interface (201), the interchange (101) transmits a confirmation message to the mobile phone (117) according to the phone number (123) provided in the text field (183). In one embodiment, the interchange (101) transmits the confirmation to the mobile phone (117) after the user is authenticated via the user interface (201) to reduce the possibility of unauthorized/unwelcome messages to the mobile phone (117), which may occur when the user intentionally or unintentionally provides an unrelated phone number in the entry box (183).

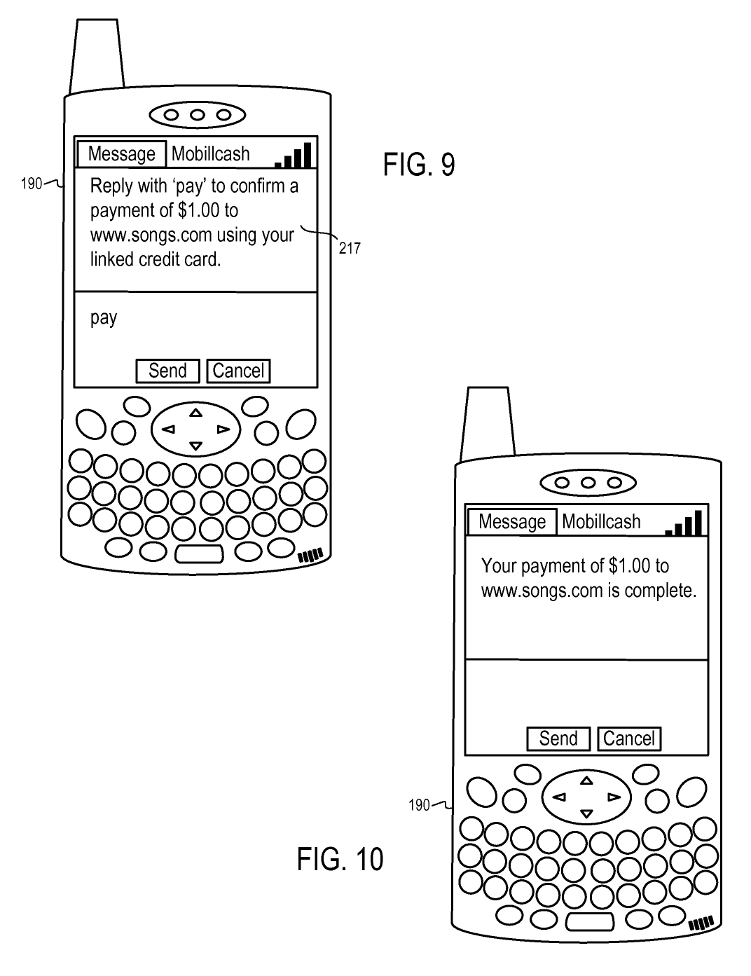

FIG. 9 illustrates a user interface to confirm a payment request according to one embodiment. In FIG. 9, the confirmation message (217) includes the amount (203) of the requested payment and the identity of the payee (e.g., a merchant operating the server (113)).

In one embodiment, the confirmation message (217) includes the instruction to reply with a code, such as a code (e.g., “pay”) provided in the confirmation message (217) as illustrated in FIG. 9.

The presence of the code in the reply message is an indication of the user approving the request; and the requirement for such a code in the reply eliminates false confirmations (e.g., generated via accidental replies or automated replies).

Alternatively or in combination, the requested code may include a PIN associated with the account, and/or a code (not shown) randomly generated and presented in the user interface used to initiate the payment transaction (e.g., user interface (201)).

In some embodiments, the code requested in the text message (217) may be a personal identification number (PIN) associated with the phone number (123). The text message (217) does not include the code; and the knowledge of the code is an indication of the identity of the user. Thus, the use of such a code increases the security of the transaction.

In a further embodiment, the code requested in the text message (217) includes a code that is provided in response to the payment request (e.g., via the user interface (201), not shown in FIG. 8). The code may be generated randomly at the time the request is received via the user interface (201), or when the user interface (201) is presented to the user. The code provided to the user interface (201) can be requested in the reply received from the user interface (190) to indicate that the user who is in possession of the mobile phone (117) has actual knowledge about the payment request submitted via the user interface (201).

After the correct reply is received, the interchange (101) communicates with the account server (125) to electronically charge the user using the account information (121) and pays the payee using the funds collected via communicating with the account server (125). The interchange (101) then notifies the user when the payment transaction is complete.

For example, the interchange (101) may notify the user via a text message to the mobile phone (117), as illustrated in FIG. 10. FIG. 10 illustrates a user interface to confirm the completion of a payment transaction according to one embodiment. No reply to the message that confirms the completion of the payment transaction is necessary. Once the payment transaction is complete, the user would have access to the product purchased via the payment transaction.

In one embodiment, the interchange (101) stores an address of the user associated with the phone number (123). After the completion of the payment transaction, the interchange (101) provides the address to the server (113) of the merchant for the delivery of the purchased product. In some embodiments, the user may provide multiple addresses associated with the phone number (123) and may select one as a delivery address in the confirmation/approve message to the interchange (101). Alternatively, the interchange (101) may receive an address for product delivery from the mobile phone (117) together with the confirmation/approve message and then forward the address to the server (113) of the merchant. Thus, the shipping address of the transaction is verified to be associated with the mobile phone (117). In alternative embodiments, the user may directly provide the shipping address in the website hosted on the server (113) of the merchant.

In other embodiments, the user is provided with the options to pay via the mobile phone bill associated with the phone number (123). The interchange (101) may dynamically calculate a set of premium messages, based on a set of limited number of predetermined prices for premium messages, to match the purchase price. The interchange (101) sends the set of premium messages to the mobile phone (117) at the phone number (123) to collect the funds via the telecommunication carriers to pay for the purchases. Thus, the purchase prices are not limited to the set of predetermined prices for premium messages. In some embodiments, the interchange (101) may send the set of premium messages in a period of time (e.g., a week, a month, a number of mouths, etc.) to spread the payments over the period of time (e.g., to overcome budget limits and/or limits imposed by regulations).

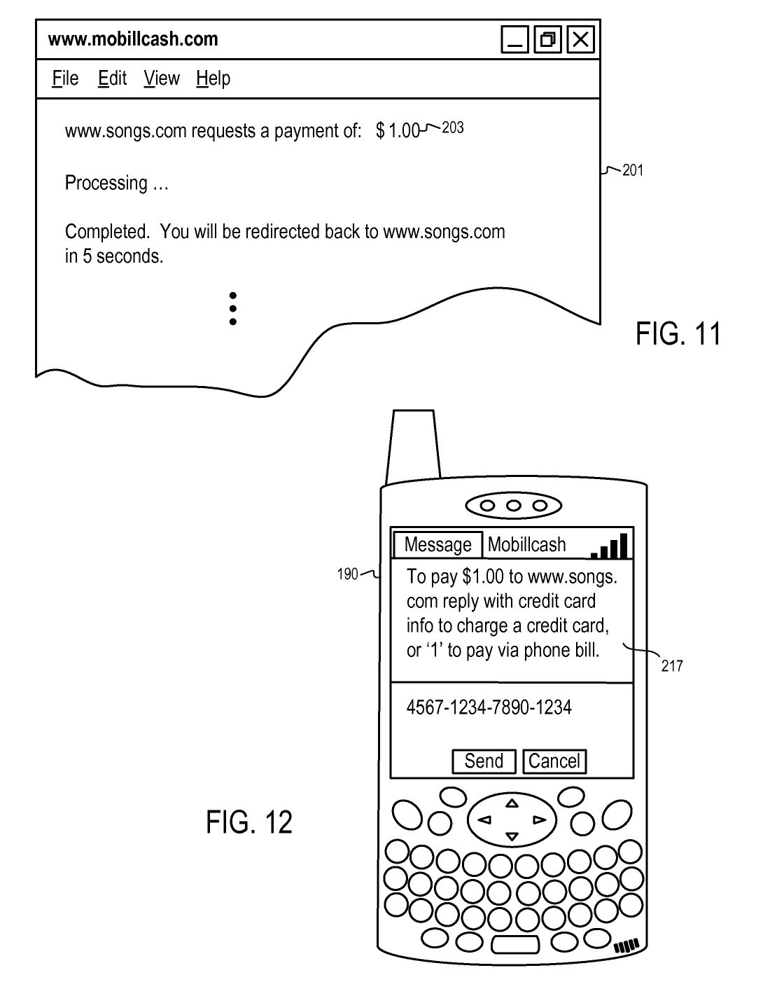

FIG. 11 illustrates a way to redirect a payment confirmation according to one embodiment. For example, after the user submits the payment request to the interchange (101) via the user interface (201) shown in FIG. 8, the interchange (101) may present the user interface (201) illustrated in FIG. 11 to the user. The user interface (201) indicates that the request is being processed; and the user interface (201) is periodically updated to show progress. Once the payment transaction is completed, the user interface (201) provides a confirmation message and may automatically redirect the user back to the website of the payee (e.g., to access the purchased products or services).

In one embodiment, the user is required to provide the approval in response to the confirmation message (217), as illustrated in FIG. 9, within a predetermined period of time. If the user fails to provide the approval from the mobile phone (117) within the predetermined period of time, the payment request may be rejected; and the user interface (201) may present a message indicating the failure and then redirect the user back to the website of the payee.

In some embodiments, instead of redirecting the user back to the website of the payee after the expiration of a predetermined period of time (e.g., after the failure of the payment process, or after the completion of the payment), the user interface (201) may provide a link to the website of the payee to allow the user to manually select the link to go back to the website of the payee to continue the process at the website of the payee.

FIG. 12 illustrates a user interface to receive payment options according to one embodiment. In FIG. 12, the interchange (101) sends a message (217) to the mobile phone (117) to provide a number of options to the user. The message (217) identifies the amount (203) of the requested payment and the identity of the payee (e.g., a merchant operating the server (113)) and asks the user to approve the payment request via a reply that contains a selected payment option.

In FIG. 12, the user may reply with the code “1” to approve the payment request and to pay via the phone bill of the mobile phone (117). Alternatively, the user may reply with the credit card information to charge the payment to a credit card, as illustrated in FIG. 12.

In one embodiment, if the user provides credit card account information in the approval message, the credit card account information is stored and associated with the phone number (123) in the data storage facility (107). Thus, in subsequent approval messages, the user does not have to supply the same information again.

For example, the data storage facility (107) may store account information for each of a plurality of account types (e.g., Visa, MasterCard, checking, savings, etc.) Thus, each of the accounts can be identified to the user via the account type in the confirmation message, without revealing the details of the account information.

For example, the interchange (101) may combine the name of the financial institutions and the type of accounts to generate aliases for the account information.

In some embodiment, the user may define the aliases for the account information by supplying the aliases with the account information (121) for association with the phone number (123).

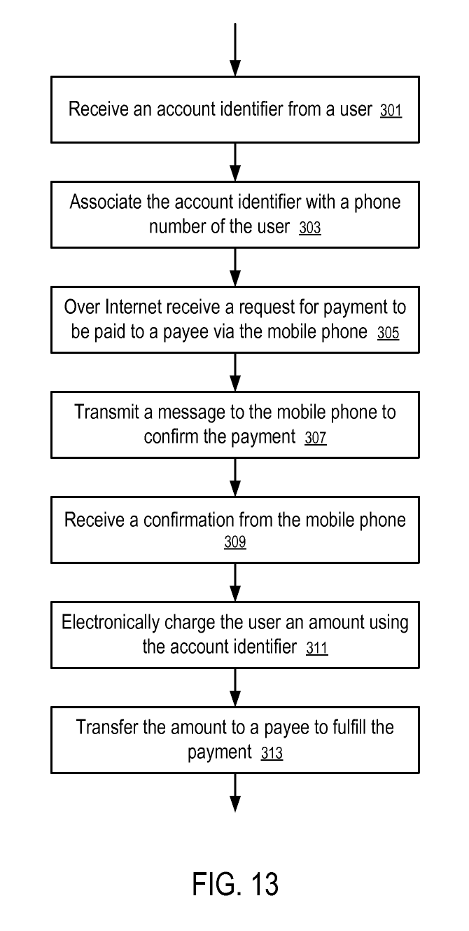

FIG. 13 shows a method to process an online payment according to one embodiment. In FIG. 13, the interchange (101) receives (301) an account identifier (e.g., 121) from a user and associates (303) the account identifier with a phone number (123) of the user in the data storage facility (107). Over the Internet the interchange (101) subsequently receives (305) a request for payment to be paid to a payee via the mobile phone (117) identified by the phone number (123). In response to the request, the interchange (101) transmits (307) a message (217) to the mobile phone (117) to confirm the payment.

After receiving (309) a confirmation or approval from the mobile phone (117) for the payment, the interchange (101) electronically charges (311) the user an amount using the account identifier (e.g., via communicating with the account server (125) using the account identifier). The interchange (101) then transfers (313) the amount to a payee to fulfill the payment.

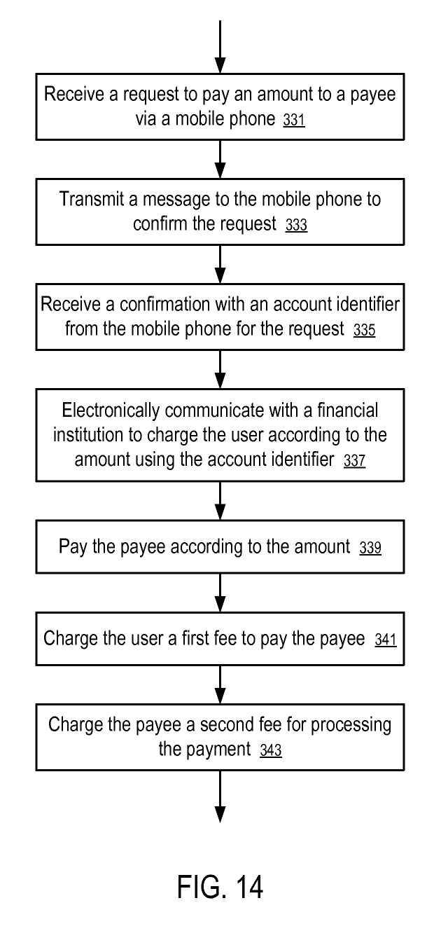

FIG. 14 shows another method to facilitate a payment transaction according to one embodiment. In FIG. 14, the interchange (101) receives (331) a request to pay an amount to a payee via a mobile phone (117). The interchange (101) transmits (333) a message (217) to the mobile phone (117) to confirm the request via the converter (131) corresponding to the controller (115) of the mobile phone (117).

After the interchange (101) receives (335) a confirmation with an account identifier (e.g., 121) from the mobile phone (117) for the request, the interchange (101) electronically communicates (337) with a financial institution to charge the user the specified amount using the account identifier. The interchange (101) pays (339) the payee according to the amount, optionally charges (341) the user a first fee to pay the payee, and optionally charges (343) the payee a second fee for processing the payment.

In one embodiment, the users are given an incentive to provide the account information (121) for electronic payments via the account servers (125). For example, the interchange (101) may charge a lower fee for fulfilling payment requests via the account server (125) than for fulfilling payments requests via the phone bill. For example, the interchange (101) may offer rebates, discounts, etc. to the users who provide the account information (121). In some embodiments, the interchange (101) can complete a payment process via the account server (125) with fewer restrictions than via the phone bill.

In one embodiment, the merchant may specify the second fee. Different merchants may offer different percentages of the purchase prices as the second fee; and the interchange (101) may calculate the first fee based on the second fee offered by the merchant, by deducting the second fee from the total fees to be charged (e.g., fees charged by the telecommunication carrier for collecting the funds via the mobile phone bill associated with the telephone number and/or the fees charged by the interchange (101) for processing the payments). Since the first fee is charged to the customer (e.g., the purchaser of products and services), the cost to the customer can vary based on the selection of the merchant. For the same purchase prices, the first fee (and thus the cost to the customer) may be different for purchases made via different merchants, because the merchants may offer different percentage of the purchase price as the second fee. In some embodiments, the first and second fees include both fees charged by the telecommunication carrier for collecting the funds via the mobile phone bill/account associated with the phone number (123) and the fees charged by the interchange (101) for processing the payments. In some embodiments, the first fee includes the fees charged by the telecommunication carrier but no fees charged by the interchange (101). In some embodiments, the second fee includes the fees charged by the telecommunication carrier but no fees charged by the interchange (101). In some embodiments, the first fee and/or the second fee do not include the fees charged by the telecommunication carrier. In some embodiments, the first fee is not charged; and in other embodiments, the second fee is not charged.

In one embodiment, a personal identification number (PIN) is used in the confirmation of a transaction. The PIN may be stored in the user account hosted on the data storage facility (107) of the interchange (101), and be associated with the phone number (123) and/or the account information (121). For example, a user requesting a transaction using the funds associated with the phone number (123) may be required by the interchange (101) to present the correct PIN associated with the phone number (123).

In some embodiments, the PIN may be the same as a PIN used by a third party to control access to products and/or services for the user having the phone number (123). For example, the PIN for accessing the voice mail of the phone number (123) can be used by the interchange (101) to verify the identity of the user who attempts to use the funds associated with the phone number (123). For example, the interchange (101) may receive a PIN from the user and communicate with a telecommunication carrier of the phone number (123) to verify whether the received PIN is a correct PIN for accessing the voice mail of the phone number (123).

In some embodiments, a correct PIN is stored on the mobile phone (117) to control access to the services of the interchange (101). For example, an application running on the mobile phone (117) may prompt the user to provide a PIN and check the PIN received from the user against the correct PIN stored on the mobile phone (117) to determine whether the user is authorized to use the mobile phone (117) to access the services of the interchange (101). In some embodiments, the PIN is specific for the control of access to the services of the interchange (101). Without the PIN, the user may use other functions of the mobile phone (117), such as making phone calls, sending emails or text messages, etc. When it is determined that the user is authorized to use services of the interchange (101) via the mobile phone (117), the application allows the user to send a confirmation message to the interchange (101) to confirm a transaction, or to display a code received from the interchange (101) for the confirmation of the transaction via presenting the code in a web page of the interchange (101).

In some embodiments, the interchange (101) requires the user to provide the PIN associated with the phone number (123) via the mobile phone (117) at the phone number (123) to confirm a transaction. The user may provide the PIN to the mobile phone (117) which transmits the received PIN to the interchange (101) for verification. The user may provide the PIN in response to a message from the interchange (101) to the mobile phone (117) at the phone number (123), or in response to the interchange (101) presenting a request on the user terminal (111) to request the user to send to the interchange (101) a confirmation message from the mobile phone (117) at the phone number (123). Alternatively, the user may provide the correct PIN in the user terminal (111) to obtain a confirmation code, which is to be transmitted from the mobile phone (117) at the phone number (123) to confirm the transaction.

In some embodiments, the user may provide the correct combination of the PIN and the phone number (123) to the user terminal (111) to request a transaction, without the need to further confirm the request via the mobile phone (117).

In one embodiment, to further improve security, the communications from the mobile phone (117) at the phone number (123) further include an identification number stored on the mobile phone (117) (e.g., in an integrated circuit (IC) chip). For example, a software program (e.g., a Java application) can be used to read a hardware identification number from the IC chip of the mobile phone (117) and transmit a confirmation message including the hardware identification to indicate that the message is indeed from a mobile phone (117) registered with the user.

In one embodiment, the International Mobile Equipment Identity (IMEI) of the mobile phone (117) is used as the hardware identification number. Alternatively, a hardware identification number may be assigned to and stored into the mobile phone (117) when the mobile phone (117) is initially configured for the services of the interchange (101) (e.g., when the application is installed on the mobile phone (117)).

In one embodiment, when the mobile phone (117) at the phone number (123) is registered for the services of the interchange (101), a software application is installed and/or configured on the mobile phone (117). The software application can be implemented using Java programming language in one embodiment. Other programming languages can also be used. Further, in some embodiments, the application can be implemented via hardware circuits, such as Application-Specific Integrated Circuit (ASIC) or Field-Programmable Gate Array (FPGA), or a combination of special purpose hardware circuits and instructions.

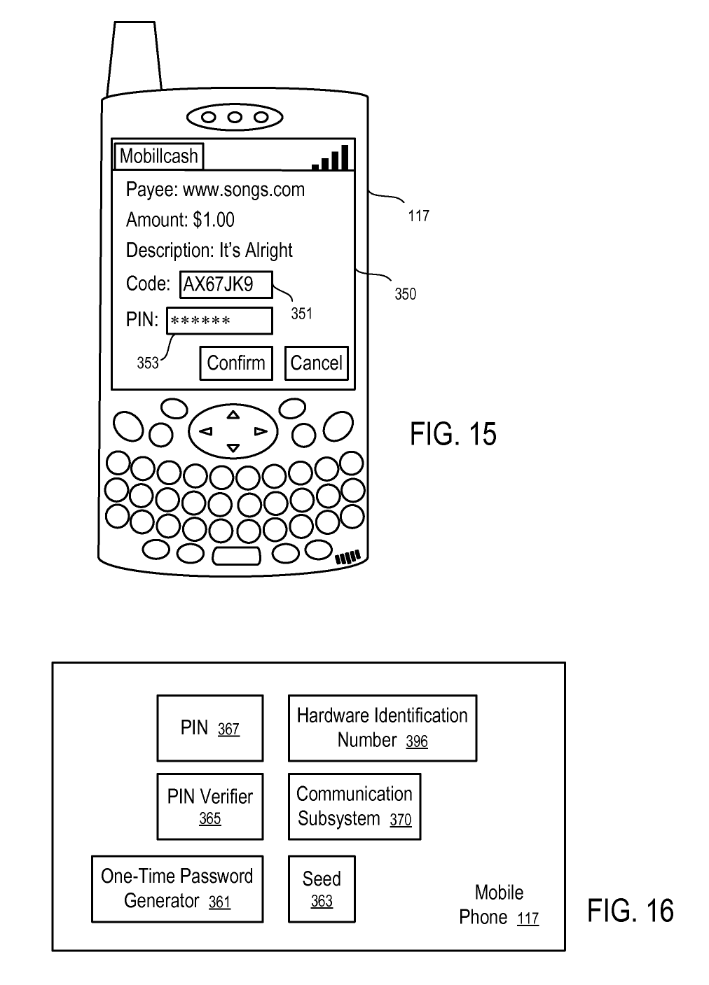

In one embodiment, the application is configured on the mobile phone (117) to present a user interface (350) to confirm a transaction according to one embodiment, as illustrated in FIG. 15. In FIG. 15, the application communicates with the interchange (101) to present information that identifies aspects of the transaction, such as the payee, the amount involved in the transaction, a description of the product or service in the transaction, etc.

In FIG. 15, the user interface (350) includes an entry box (353) to receive a PIN from the user. When the PIN received in the user interface (350) is invalid, the user interface (350) may reject the input and prevent the user from sending the confirmation message via the user interface (350).

Alternatively, the user interface (350) may accept the user input without checking the input for validity and transmit the confirmation with the received PIN to the interchange (101). The interchange (101) then checks the received PIN for validity. If the interchange (101) determines that the received PIN is valid for the phone number (123) of the mobile phone (117), the interchange (101) accepts the confirmation and performs the requested transaction. If the interchange (101) determines that the received PIN is invalid, the user interface (350) may prompt the user to re-enter the PIN.

In some embodiments, the user interface (350) and/or the interchange (101) may prevent the user from using the user interface (350) after the user fails to provide the correct PIN after a predetermined number of attempts.

In FIG. 15, the user interface (350) further includes an entry box for the user to enter a code (351) that represents the transaction. For example, when the user uses the user terminal (111) to submit a transaction request (e.g., via a web browser), the interchange (101) provides the code (351) as an identifier of the transaction.

In one embodiment, after the user enters the code (351) in the entry box, the application running the user interface (350) communicates with the interchange (101) to obtain the information about the transaction, such as the payee, the amount of the transaction, a description, etc. Thus, providing the code (351) in the entry box allows the user to see in the user interface (350) the information specific to the transaction for the confirmation of the correct transaction.

In one embodiment, the code (351) is a one-time code, which expires after the code is submitted to the interchange (101). To improve security, the interchange (101) may cause the one-time code (351) to expire after a predetermined period of time from when the one-time code (351) is provided by the interchange (101) to the user. When the one-time code (351) or the PIN is incorrect, the interchange (101) rejects the confirmation. After an incorrect combination of the PIN and the one-time code (351) is received, the interchange (101) may cause the one-time code (351) to expire; and the user is prompted to resubmit the transaction request to obtain a new one-time code.

In some embodiments, the interchange (101) may allow the user interface (350) to resubmit the input for the PIN a number of times if the one-time code (351) is valid. For example, the user interface (350) may be presented in response to a message from the interchange (101) requesting the confirmation of the transaction. The one-time code (351) is required in the entry box to ensure that the user has knowledge about the transaction submitted via the user terminal (111). The PIN is required in the entry box (353) to ensure that the user is authorized. In some embodiments, the one-time code (351) is optional.

In some embodiments, the interchange (101) provides the one-time code (351) to the user via the user interface (350). The application may send the one-time code (351) back to the interchange (101) to identify the transaction being confirmed by the user.

Alternatively, the interchange (101) may require the user to provide the one-time code (351) back to the interchange (101) via the user terminal (111) that submits the corresponding transaction request. After the one-time code (351) shown in the user interface (350) on the mobile device (117) is transmitted from the user terminal (111) to the web server of the interchange (101), the transaction is confirmed with the interchange (101).

In one embodiment, the PIN is used to protect access to the one-time code (351). The user interface (350) is configured to display the one-time code (351) after the user enters the correct PIN in the entry box (353). If the user fails to enter the correct PIN in the entry box (353), the user interface (350) does not display the one-time code (351) which is required in the user terminal (111) to confirm the transaction.

In one embodiment, the code (351) is a one-time password, which is generated on the mobile phone (117). The one-time password is provided to the interchange (101) to confirm the transaction (e.g., via the mobile phone (117) communicating with the interchange (101), or via the user terminal (111) communicating with the interchange (101)).

In one embodiment, the one-time password is generated on the mobile phone (117) after the request for the transaction is submitted to the interchange (101) via the user terminal (111). The one-time password is not received in the mobile phone (117) from the interchange (101) as a result of the transaction request. In one embodiment, the one-time password is generated based at least in part on a seed that is configured in the mobile phone prior to the transaction.

In one embodiment, the one-time password is generated on the mobile phone (117) after the PIN is verified in the entry box (353). If the PIN entered in the entry box (353) is invalid, the mobile phone (117) does not generate the one-time password.

In one embodiment, the user is instructed to use the one-time password to authenticate with the interchange (101), using the user terminal (111) that submits the request for the transaction. Alternatively, the mobile phone (117) may transmit the one-time password to confirm the transaction. In some embodiments, the mobile application generates the one-time password and transmits the one-time password to the interchange (101) to confirm the transaction, without displaying the one-time password to the user, after the user enters the correct PIN.

In one embodiment, the correct PIN is stored on the mobile phone (117) (e.g., in an encrypted format). Thus, the user interface (350) can verify the PIN entered in the entry box (353) without communicating with the interchange (101).

Alternatively, the correct PIN may be stored on the data storage facility (107) of the interchange (101). The application running on the mobile phone (117) communicates the PIN received in the entry box (353) to the interchange (101) (e.g., in an encrypted format) for verification.

Alternatively, a third party may store the correct PIN (e.g., for controlling access to the voice mail of the phone number (123)). After the interchange (101) obtains the PIN received in the entry box (353), the interchange (101) communicates with the third party to verify the PIN.

FIG. 16 illustrates a mobile phone configured to confirm transactions according to one embodiment. In FIG. 16, the mobile phone (117) includes a hardware identification number (396) which identifies the mobile phone (117). In one embodiment, the hardware identification number (396) is configured and stored on the mobile phone (117) prior to the mobile phone (117) being distributed to end users. For example, the hardware identification number (396) may include International Mobile Equipment Identity (IMEI) and/or Media Access Control address (MAC address).

In some embodiments, the hardware identification number (396) includes a number that is assigned to the mobile phone (117) when the mobile phone (117) is registered with the interchange (101) for the services provided by the interchange (101). For example, the interchange may use an application to write the assigned number into an integrated circuit (IC) chip in the mobile phone to identify the mobile phone (117). In some embodiments, the assigned number is written into a removable memory module to represent the registered mobile phone (117).

In FIG. 16, the mobile phone (117) includes a seed (363) for the one-time password generator (361). The one-time password generator (361) is configured to generate a series of passwords for authenticating with the interchange (101), based on the seed (363) and/or the current time. Thus, the one-time password generated on the mobile phone (117) is in synchronization with the corresponding one-time password generated or used on the interchange (101). Alternatively, the one-time password generator (361) may not rely upon the current date and time for synchronization; and the interchange (101) is configured to tolerate skipping of up to a predetermined number of one-time passwords to accept a one-time password from the mobile phone (117).

In one embodiment, the PIN verifier (365) is configured to check the PIN received in the entry box (353) against the PIN (367) stored on the mobile phone (117). After the PIN verifier (365) determines that there is a match between the PIN (367) stored on the mobile phone (117) and the PIN received in the entry box (353), the communication subsystem (37) transmits a one-time password obtained from the one-time password generator (361) and the hardware identification number (396) to the interchange (101) to confirm the transaction. In one embodiment, the one-time password is used to encrypt the confirmation transmitted from the mobile phone (117) to the interchange (101) to confirm the transaction.

The mobile phone (117) may transmit the confirmation message to the interchange (101) via short message service (SMS), email, a WAP request, or a web request. Other communication protocols can also be used.

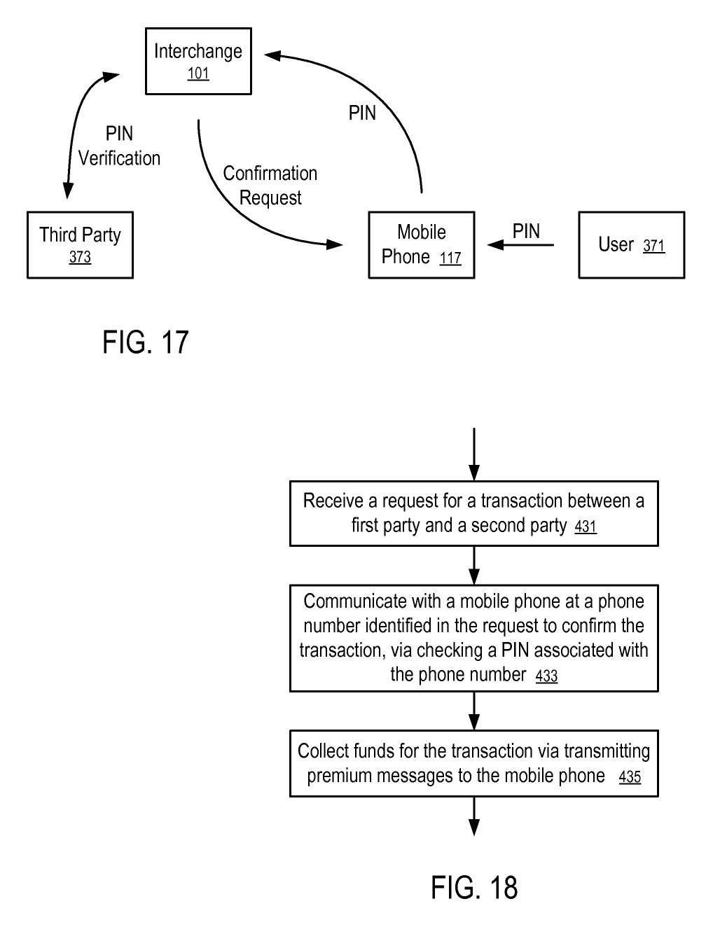

FIGS. 17-19 illustrate methods to confirm transactions according to one embodiment.

In FIG. 17, neither the interchange (101) nor the mobile phone (117) stores the correct PIN associated with the phone number of the mobile phone (117). A third party (373) stores the correct PIN associated with the phone number (123) of the mobile phone (117). To confirm a transaction, the interchange (101) transmits a message to the mobile phone (117) at the phone number (123) to request a confirmation message from the mobile phone (117). The mobile phone (117) presents a user interface (e.g., 350) to receive an input for the PIN from the user (371) and transmits the received PIN to the interchange (101), which further communicates with the third party (373) to verify whether the received PIN matches the correct PIN. Thus, the user may use the same PIN for multiple services associated with the phone number (123), such as accessing voice mail at the phone number (123) and paying for purchases using funds associated with the phone number (123).

In FIG. 18, after a request for a transaction between a first party and a second party (431) is received in the interchange (101) (e.g., via a web server), the interchange (101) communicates (433) with the mobile phone (117) at a phone number (123) identified in the request to confirm the transaction, via checking a PIN associated with the phone number (123). The transaction is confirmed if a PIN entered into the mobile phone (117) by the user of the mobile phone (117) is correct. After the transaction is confirmed, the interchange (101) collects (435) funds for the transaction via transmitting premium messages to the mobile phone (117).

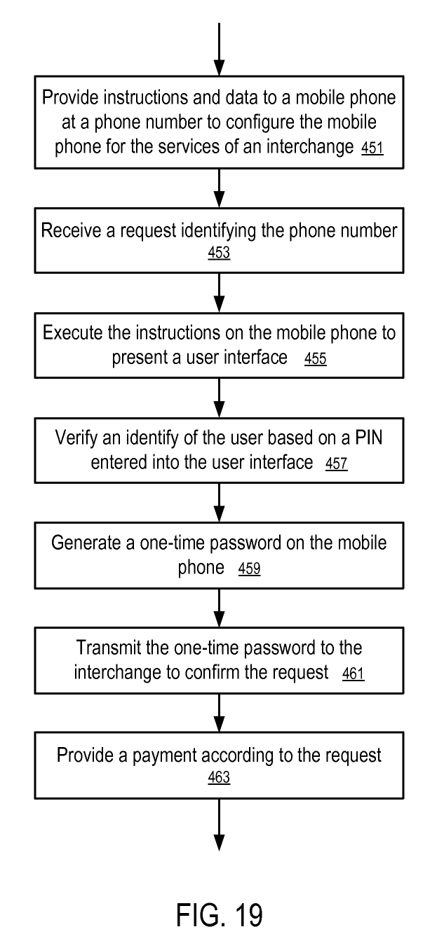

In FIG. 19, the interchange (101) provides (451) instructions and data to a mobile phone (117) at a phone number (123) to configure the mobile phone (117) for the services of the interchange (101). The instructions may be in Java programming language, or other programming languages. The data may include a seed (363) for the one-time password generator (361) and/or a portion of the hardware identification number (396). For example, the user may use the mobile phone (117) to download the instructions and data from the interchange (101).

After the mobile phone (117) is configured via the instructions and data, the interchange (101) may receive (453) a request identifying the phone number (123) and transmit a message to the user (371) to cause the mobile phone (117) to execute (455) the instructions on the mobile phone (117) to present a user interface (350). After the identify of the user (371) is verified (457) based on a PIN entered into the user interface (350), the mobile phone (117) generates (459) a one-time password on the mobile phone (117) and transmits (461) the one-time password to the interchange (101) to confirm the request. Once the request is confirmed via the confirmation transmitted from the mobile phone (117), the interchange (101) provides (463) a payment according to the request (e.g., using funds associated with the phone number (123)).

In one embodiment, the interchange (101) includes a server computer. The server computer may be used to receive a request for a transaction between a first party and a second party. The request includes the indication of a phone number of the first party and an amount to be paid to the second party.

In response to the request, the server computer communicates with a mobile phone (117) at the phone number (123) to confirm, via a personal identification number of the first party, the transaction. After the transaction is confirmed via the personal identification number of the first party, the server computer transmits one or more premium messages to the mobile phone (117) to collect, via a telecommunication carrier of the mobile phone (117), funds in accordance with the amount to be paid to the second party.

In one embodiment, the interchange (101) provides instructions to the mobile phone (117). When executed, the instructions cause the mobile phone (117) to present a user interface to receive a first personal identification number.

The instructions may further cause the mobile phone (117) to encrypt the first personal identification number for transmission from the mobile phone (117) to the server computer. The server computer is to compare the first personal identification number with a second personal identification number associated with the phone number (123) of the mobile phone (117) to determine whether the transaction is confirmed.

Alternatively, the instructions may further cause the mobile phone (117) to compare the first personal identification number with a second personal identification number stored on the mobile phone (117) to determine whether the first personal identification number is correct. After determining that the first personal identification number is correct, the instructions further cause the mobile phone (117) to transmit a message to the server computer to confirm the transaction.

In one embodiment, the instructions further cause the message to include a hardware identification code of the mobile phone (117). The hardware identification code may be provided to the mobile phone (117) in a read-only memory, before the mobile phone (117) is distributed to an end user. For example, the hardware identification code may include International Mobile Equipment Identity (IMEI).

In some embodiments, the hardware identification code is provided to the mobile phone (117) when the mobile phone (117) is registered with the server computer for services offered by the server computer.

In one embodiment, the instructions further cause the mobile phone (117) to transmit the message to the server computer via short message service (SMS). In some embodiments, the message includes a one-time password generated via the instructions. For example, the one-time password can be generated based on a current time; and the server computer is to determine whether the one-time password is generated by the mobile phone (117). When the one-time password matches a series of passwords configured to be generated by the mobile phone (117), the one-time password is accepted. In one embodiment, the server computer provides to the mobile phone (117) at the phone number (123), a seed for generation of the one-time password, which is used by the instructions to generate the one-time password.

In one embodiment, the server computer provides the first party with a seed for one-time password generation when the first party registers for services of the server computer; and the instructions cause the mobile phone (117) to present a user interface to receive the seed.

In one embodiment, the server computer is to further communicate with a third party to determine whether the first personal identification number received in the user interface is associated with the phone number (123) of the mobile phone (117). For example, the third party may be a telecommunication carrier of the mobile phone (117); and a correct personal identification number is used by the telecommunication carrier to control access to voice mails for the phone number (123).

In one embodiment, the request is received in a web server of the server computer; the server computer communicates with the mobile phone (117) to provide a one-time code to the mobile phone (117), after the personal identification number of the first party is verified via the mobile phone (117); and the server computer is configured to receive the one-time code back in the web server to confirm the transaction.

In one embodiment, the request is received in a web server of the server computer; the server computer provides a one-time code via the web server to the first party; and the server computer is configured to determine whether the transaction is confirmed based on receiving, from the mobile phone (117), both the personal identification number of the first party and the one-time code.

In one embodiment, the interchange (101) includes an application programming interface (API) to allow the automation of tasks related to payment requests. For example, merchants and publishers of software and applications, such as games, ecommerce sites, or sites that provide premium information, can use the API to develop mobile or online applications which allow their customers to pay for goods or services using their mobile phones (117). The interchange (101) can use the API to receive payment requests and may fulfill the payment requests using the funds collected via the phone bills associated with the phone numbers (123), or via other funding sources, such as credit cards, debit cards, bank cards, etc.

In one embodiment, a software development kit (SDK) is provided to aid in the development of mobile applications. The SDK includes a set of instructions that can be distributed as part of a mobile application (or a mobile component that can support the mobile application). The instructions of the SDK are configured to programmatically determine the Mobile Subscriber Integrated Services Digital Network Number (MSISDN) of the mobile phone (117) on which the mobile application is running.

In one embodiment, the instructions of the SDK are further configured to provide a list of available/valid price points for the MSISDN of the phone (e.g., by consulting a backend service running on the interchange (101), which maps the MSISDN to a carrier, and therefore the matrix of available price points).

In one embodiment, the instructions of the SDK are configured to provide a charge request function to receive a charge request at a specific price point, to submit a charge request from the mobile phone (117) to the interchange (101), and to provide a result code for a pending charge request.

In one embodiment, when given a price point and the merchant ID, the SDK is to determine the MSISDN of the mobile phone (117) and package the MSISDN along with the price point and the merchant ID into a charge request packet. The charge request packet can be hashed/encrypted using a public key associated with the merchant to protect the communication. The hashed request can be sent by the SDK from the mobile phone (117) to the interchange (101) via Hypertext Transfer Protocol (HTTP), using a data connection available on the mobile phone (117), or possibly SMS or MMS if an IP connection is not available on the mobile phone (117).

In one embodiment, the interchange (101) decrypts and validates the request using the private key associated with the merchant ID. The merchant ID may be transmitted from the mobile phone (117) to the interchange (101) without encryption (e.g., in the clear), or using a separate encryption key. After the interchange (101) determines the merchant ID, the interchange (101) can look up the private key associated with the merchant ID to decrypt and validate the request.

In one embodiment, the interchange (101) is configured to process the payment request using the MSISDN, which identifies the phone number (123) of the mobile phone (117). For example, the interchange (101) may transmit a premium SMS message to the mobile phone (117) having the MSISDN to collect funds for the payment request via the mobile carrier of the mobile phone (117). Alternatively, the mobile phone (117) having the MSISDN may be associated with account information (121) identifying other funding sources, such as a debit or credit card, an ACH debit, a wallet deduction from a stored value account hosted on the interchange (101) or a third party, etc.; and the interchange (101) is configured to use the corresponding funding source(s) to fulfill the payment request.

In one embodiment, after the successful completion of the payment transaction, the interchange (101) transmits one or more messages to the mobile phone (117); and the SDK is configured to monitor the incoming SMS queue/inbox on the mobile phone (117) to detect the arrival of the messages. When the messages from the interchange (101) are detected in the SMS queue/inbox, the SDK is configure to notify the mobile application that the charge has been successful. Thus, the mobile application may allow the user of the mobile phone (117) to access the goods or services purchased by the user.

For example, when the funds for settling the payment request are collected via one or more premium SMS messages, the SDK is configured to monitor the SMS inbox for the arrival of the premium SMS messages initiated from the interchange (101). Upon detection of the premium SMS messages corresponding to the payment request in the SMS inbox, the SDK calls a function of the mobile application to facilitate the release of the goods or services purchased by the user.

In another example, the SDK is configured to provide mobile initiated premium SMS messages from the mobile phone (117) to the interchange (101) to instruct the mobile carrier of the mobile phone (117) to provide funds to the interchange (101). After the interchange (101) receives the mobile initiated premium SMS messages, the interchange (101) may provide a confirmation message to the mobile phone (117) via short message service (SMS), which may be a zero-rated SMS (or MMS) message. Upon detection of the zero-rated message confirming the reception of the mobile initiated premium SMS messages, the SDK invokes the mobile application to allow the mobile application to release the goods or services purchased by the user.

Alternatively, the SDK running on the mobile phone (117) may request the interchange (101) to use other funding sources supported by the account information (121) associated with the phone number (123) in the data storage facility (107) of the interchange (101), such as credit card accounts, debit card accounts, bank accounts, or accounts hosted on payment intermediary services, such as accounts associated with email addresses of the users on the payment intermediary services. In one embodiment, the SDK is configured to obtain from the interchange (101) a list of funding sources, and allow the user to select one from the list of funding sources specified by the account information (121). For example, a list of aliases or nicknames of the funding sources can be presented to the user to allow the user to use one or more of the funding sources to fulfill the payment request.

In one embodiment, the confirmation of the successful processing of the payment request by the interchange (101) is communicated to the mobile phone (117) via an SMS/MMS message transmitted from the interchange (101) to the mobile phone (117). Alternatively, the SDK running on the mobile phone (117) may use the IP connection on the mobile phone (117) to check for the status of the payment request (e.g., periodically). In some embodiments, the interchange (101) may provide an estimated time period for the completion of the payment processing, as a response to the inquiry from the SDK running on the mobile phone (117); and the mobile phone (117) is configured to wait for a time period according to the estimation, before sending the next inquiry for the status of the same payment request. For example, the SDK may send the status inquiry via an HTTP request from the mobile phone (117).

In one embodiment, mobile application developers can use the SDK to accept payments via the interchange (101) within their native mobile application or compatible mobile web browser without the user having to exit the mobile application to use the services of the interchange (101). For example, the mobile application developers can install the SDK in a way native to that mobile operating system running one the mobile phone (117). The SDK serves as a payment proxy between the mobile application provided by the mobile application developer, mobile operating system programming interfaces, and the interchange (101).

In one embodiment, the SDK serves as an intermediary application and resides in the mobile phone (117). In one embodiment, the SDK resides in the mobile application provides by the mobile application developer.

In one embodiment, the SDK is configured to create, receive, and send messages to or from the interchange, such as premium messages for collecting funds for payments and SMS messages for the conformation of a payment request, in accordance with mobile network billing protocols and standards.

In one embodiment, when the SDK is used, the end user of the mobile phone (117) does not have to leave the user interface of the mobile application to make payments. The messages, such as SMS confirmation message and/or premium SMS for the collection of funds, can be created by the SDK on behalf of the end user and the mobile application for in application billing as well as paying for an application. Without the SDK, the end user would have to leave the user interface of the mobile application, enter into the native operator system and send or reply to a premium message that will bill the user through the mobile network operator billing service.

In one embodiment, the SDK works for mobile and software applications written in the native operating language for such platforms as Apple, Google-Android, Nokia-Symbian, RIM, J2ME, BREW, LiMo, Windows, and Flash as well as any other future mobile development and operating systems.

In one embodiment, the SDK also works for mobile browser based applications, or native applications that utilize mobile browser as a display mechanism. These browsers include applications written using layout engines including Webkit, WAP (XHTML1.0, 2.0+), WML, HDML.

In one embodiment, various browser technologies can use the SDK through web OS technology aimed at mobile devices and mobile OS device interfaces such as BONDI from OMTP (Open Mobile Terminal Platform). A web OS application, using the BONDI supported interfaces for the phone, can use the SDK as the proxy application to create, receive, and send necessary messages (e.g., premium SMS and SMS) to properly create a payment transaction that conforms to all SMS and premium SMS mobile network billing protocols and standards. Thus, the user in the mobile browser application or site does not have to leave that application to utilize the service of the interchange (101); and the SDK is to interact with the mobile browser application and the mobile operating system for PSMS/SMS construction, sending and receipt, and the mobile billing payment network.

In one embodiment, the SDK is also configured to work with runtime widget technologies such as JIL (joint innovation lab) standards, Yahoo Mobile, and Plusmo, Inc.

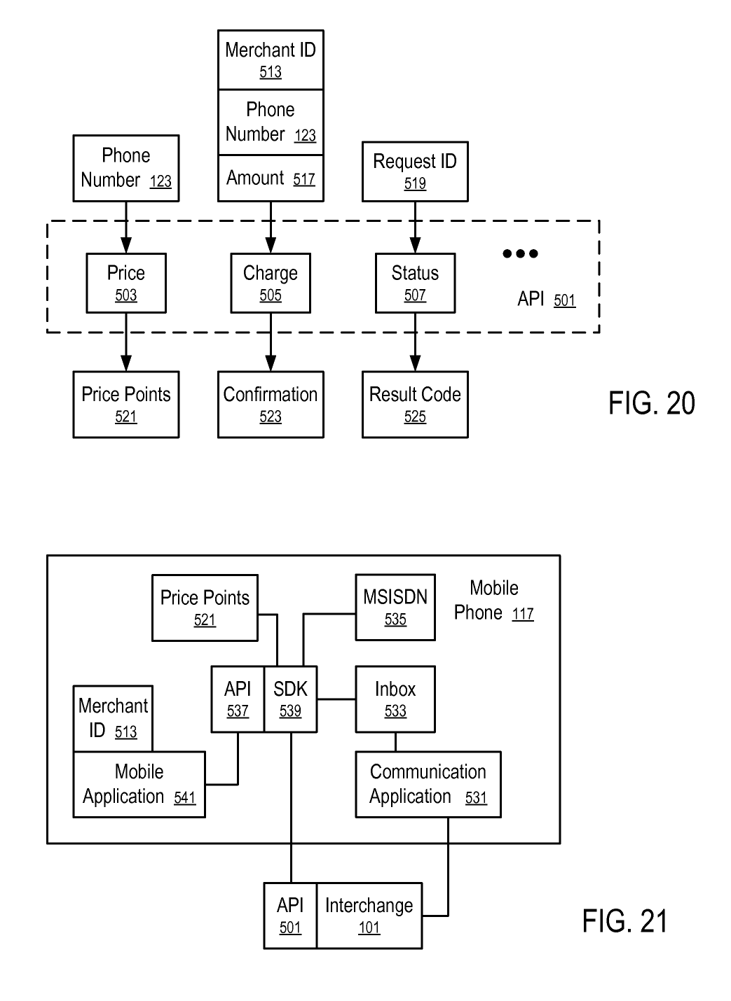

FIG. 20 illustrates an application programming interface (API) according to one embodiment. In one embodiment, the API (501) is implemented as a web service of the interchange (101). Alternatively, the API (501) can be implemented via remote procedure call (RPC), or custom communication protocols.

In one embodiment, the API (501) includes a set of functional interfaces, such as interfaces for price (503), charge (505) and status (507). Each of the functional interfaces is configured to receive one or more parameters for a request; and the interchange (101) may or may not provide an immediate reply as a response. A combination of the functional interfaces (e.g., 503-507) can be used by a program to automate the tasks to process a payment request.

For example, in FIG. 20, the API (501) includes a functional interface (503) to query for the price points (521) supported by the account associated with the phone number (123). In one embodiment, the interchange (101) is configured to charge the account of the user via premium messages to or from the mobile phone (117) at the phone number (123). The telecommunication carrier of the mobile phone (117) allows premium messages to be charged to the phone bill of the user according to a limited set of discrete prices for the premium messages. Further, regulations and policies may impose a limit on the total amount and/or the total number of premium messages that can be charged to the user within a period of time. Thus, the allowable prices that the interchange (101) can charge the user on the phone bill of the mobile phone (117) via the premium messages can be limited to a set of price points (521).

In one embodiment, the interchange (101) is configured to determine the price points (521) based on the identification of the telecommunication carrier, regulations, policies, and/or prior transactions that occurred within a period of time. For example, the common format processor (133) illustrated in FIG. 3 can be used to determined the price points (521) based on the rules (141), regulations (143), limits (145), records (147), and restrictions (149). The interchange (101) determines the price points (521) and provides the price points (521) as a response to the request submitted according to the price interface (503).

In one embodiment, the MSISDN of the mobile phone (117) is used in the API (501) to specify the phone number (123). For example, a software component can be installed on the mobile phone (117) to automatically/programmatically determine the MSISDN of the mobile phone (117), without the user having to manually specify the phone number (123). Alternatively, the user may be required to enter the phone number (123) via a user interface, before an application (e.g., a mobile application, a web application, etc.) uses the API (501) to submit the request to the interchange (101).

In FIG. 20, the API (501) includes a functional interface (505) to submit a charge request. The charge request includes parameters, such as the merchant ID (513), the phone number (123), and the amount (517) of the funds to be charged. The merchant ID (513) identifies the recipient of the funds generated from the charge. The phone number (123) identifies the account of the user, from which the funds are collected.

In one embodiment, as a response to the charge request, the interchange (101) provides the confirmation (523), which may include an identifier assigned to represent the charge request, such as the request ID (519). The identifier may be generated from information known to the requester, such as a combination of the merchant ID (513) and a time stamp of the request, in which case it may not be necessary for the interchange (101) to explicitly provide the identifier in the confirmation (523). Alternatively, the identifier may include information that is generally unknown to the requester, such as a sequence number, or a one time code assigned to the charge request. In some embodiments, the requester may specify an identifier for the requester as part of the input parameter for the charge request.

In some embodiments, the charge request further includes an input parameter that identifies the goods or services to be paid for by the charge request. For example, the input parameter may include a brief description of the goods or services, a stock-keeping unit (SKU) number, a unit price and/or the number of units purchased, etc. The description can be used in a confirmation message transmitted from the interchange (101) to the mobile phone (117) for the confirmation of the charge request.

In one embodiment, after the charge request is received via the API (501), the interchange (101) is configured to communicate with the mobile phone (117) at the phone number (123) to confirm the charge request. After the interchange (101) confirms the charge request with the user of the mobile phone (117), via communicating with the mobile phone (117), the interchange (101) charges the user via premium messages to (or from) the mobile phone (117).

In some embodiments, the API (501) may further include an additional interface to query for a list of identifiers of funding sources associated with the phone number (123); and the charge request may further include an additional parameter to specify a funding source selected from the list. For example, the user may choose to charge a credit card associated with the phone number (123) for the purchase, instead of paying via the premium messages charged to the phone bill of the mobile phone (117). In some embodiments, the list of identifiers is provided together with the price points (521).

In one embodiment, there is generally an unknown period of delay between the charge request and the completion of the charge (e.g., via the premium message). For example, communications with the mobile phone (117) at the phone number (123) may take an unknown period of time. The API (501) provides a functional interface (507) to allow the requester to query for the current status of a charge request, identified by the request ID (519). As a response to the status inquiry, the interchange (101) provides the result code (525). For example, a result code (525) may indicate that the charge request is currently pending, has been completed successfully, or was rejected/declined by the user of the mobile phone (117) at the phone number (123), etc.

In some embodiments, the API (501) for the charge (505) request includes a parameter to specify a callback URL. The interchange (101) stores the callback URL with the charge request. When the charge request is completed successfully, the interchange (101) is to visit the callback URL to report the success of the charge request. In some embodiments, the callback URL may include a parameter to indicate the status of the charge request (e.g., pending, declined, successful, etc.). Alternatively, different URLs may be specified to report different possible outcomes for the charge request (e.g., successful, not successful). Once the callback URL is specified, the request does not have to query the interchange (101) periodically for the status of the charge request, since the interchange (101) is configured to automatically report the outcome of the charge request using the callback URL.

In one embodiment, the communications via the API (501) is performed over a secure authenticate channel to improve security. Thus, the interchange (101) accepts queries/requests from known, authenticated web locations of merchants and rejects queries/requests from unknown, unauthenticated web locations.

In some embodiments, the applications using the API (501) may be configured to run on the user terminals (111) of the customers, or the mobile phones (117) of the customers. The requests may be encrypted at least in part via public keys associated with the merchants. The interchange (101) stores the private keys associated with the merchants. Thus, the encrypted content of the requests can be decrypted only through the use of the corresponding private keys accessible to the interchange (101) but generally not to others.

FIG. 21 illustrates a software development kit (SDK) according to one embodiment. In one embodiment, the SDK (539) includes instructions configured to be executed on the mobile phone (117). The instructions of the SDK (539) can be configured for distribution as part of the mobile application (541), or configured as a helper component installed on the mobile phone (117) on which the mobile application (541) is running.

In one embodiment, the SDK (539) is configured to programmatically determine the MSISDN (535). For example, in one embodiment, the MSISDN (535) is stored in the mobile phone (117) (e.g., in the SIM card of the mobile phone (117)); and the SDK (539) is configured to automatically read the MSISDN (535) from the memory of the mobile phone (117). Alternatively, the SDK (539) may be configured to obtain the MSISDN (535) of the mobile phone (117) from the telecommunication carrier of the mobile phone (117).

In one embodiment, the SDK (539) is configured to automatically obtain the price points (521) for the mobile phone (117) (e.g., using the price (503) interface of API (501)). The SDK (539) provides the price points (521) to the mobile application (541) via an API (537). Thus, the mobile application (541) can use the price points (521) to provide offers of goods and/or services in alignment with the price points (521). For example, the mobile application (541) may bundle goods and/or services so that the price of a bundle is at one of the price points (521).

In one embodiment, the mobile application (541) is configured to include the merchant ID (513). The mobile application (541) uses the API (537) to request the SDK (539) to submit the charge request to the interchange (101) (e.g., via the API (501)).

In one embodiment, the SDK (539) is configured to package the merchant ID (513), MSISDN (535) and the price of the charge request in a packet for transmission to the interchange (101). The request packet may be transmitted from the mobile phone (117) via an IP connection (e.g., using HTTP) or via a communication application (531) (e.g., an SMS application of the mobile phone (117)).

In one embodiment, the SDK (539) is configured to ensure the security and integrity of the request packet. For example, the SDK (539) can be configured to include the security features as illustrated in and discussed in connection with FIG. 16. Further, the mobile application (541) or the SDK (539) may include a public key associated with the merchant to encrypt the request packet. In one embodiment, SDKs (539) for different merchants are customized with different merchant IDs (513) and the associated public keys. Alternatively, the merchant ID (513) and the respective public key can be provided as configuration parameters of the SDK (539).

In one embodiment, the SDK (539) is configured to monitor the inbox (533) to which the interchange (101) transmits various messages, such as confirmation messages, premium messages, etc.

In one embodiment, the SDK (539) is configured to monitor the inbox (533) for a confirmation message that requests a response from the user of the mobile phone (117) to confirm the charge request. Upon detection of such a confirmation message, the SDK (539) informs the mobile application (541) and/or the communication application (531) to prompt the user to provide a response.

In some embodiments, since the initial charge request is transmitted from the mobile phone (117) via the SDK (539), the interchange (101) may skip the additional communication with the mobile phone (117) for the confirmation of the request. In some embodiments, the SDK (539) may request the user to enter a correct PIN (367) before the packet for the charge request is sent from the mobile phone (117) to the interchange (101).

In one embodiment, the SDK (539) is configured to monitor the inbox (533) for the status or outcome of the charge request. For example, when the funds for the charge are collected via one or more premium messages, the SDK (539) is configured to determine whether the entire set of premium messages expected for the amount specified in the request packet has arrived in the inbox (533). Upon detection of the arrival of the entire set of the premium message for the charge request, the SDK (539) is to notify the mobile application (541) via the API (537) (e.g., through a callback function of the mobile application (541), a register, or other communication channels). This notification allows the mobile application (541) to promptly release the goods and/or services purchased by the user after the payment for the goods and/or services is successfully processed by the interchange (101).

In one embodiment, the SDK (539) is configured to provide funds via transmitting mobile initiated premium messages to the interchange (101). The interchange (101) is configured to transmit a notification message to the inbox (533) of the mobile phone (117) (e.g., via the communication application (531)), after the mobile initiated premium messages are received in the interchange (101). The SDK (539) is configured to detect the notification message and inform the mobile application (541) about the success in receiving the premium messages in the interchange (101).

In some embodiments, the charge request may include an identification of a funding source associated with the mobile phone (117) represented by the MSISDN (535), such as a credit card account, a debit card account, a bank account, etc. The account information (121) may be pre-configured on the interchange (101) as associated accounts of the phone number (123), or transmitted with the charge request (e.g., when an associated account is first used on the interchange (101) to fund a charge request).

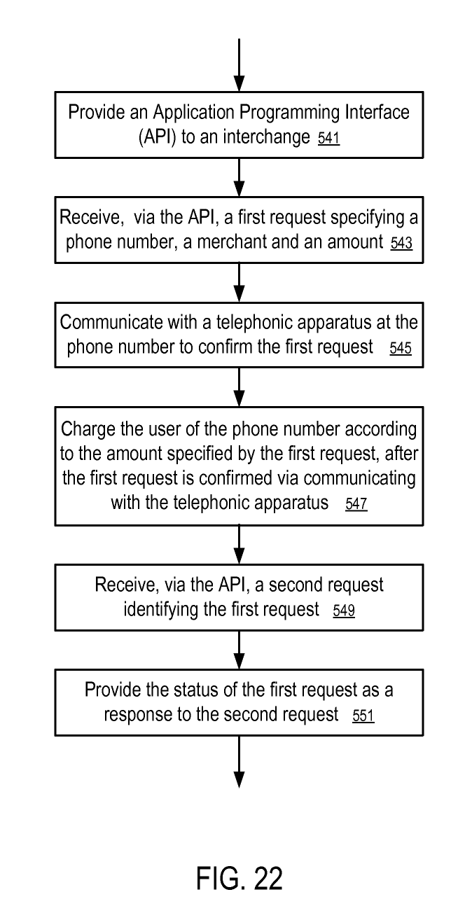

FIG. 22 illustrates a method to process transaction requests according to one embodiment. In FIG. 22, an Application Programming Interface (API) (501) to an interchange (101) is provided (541) (e.g., via a web service). The interchange (101) is configured to receive (543), via the API (501), a first request (505) specifying a phone number (123), a merchant (513) and an amount (517), to communicate (545) with a telephonic apparatus (e.g., mobile phone (117)) at the phone number (123) to confirm the first request (505), to charge (547) the user of the phone number (123) according to the amount (517) specified by the first request (505), after the first request (505) is confirmed via communicating with the telephonic apparatus, to receive (549), via the API (501), a second request (507) identifying the first request (505), and to provide (551) the status of the first request (505) as a response to the second request (507).

In one embodiment, the interchange (101) provides the identification of the first request as part of the confirmation of the first request (505) in accordance with the API (501).

In one embodiment, the interchange (101) is configured to receive a third request (503) identifying the phone number (123). In response to the third request (503), the interchange (101) is to identify a mobile carrier of the phone number (123), determine a set of discrete price points (521) supported by the mobile carrier for the phone number (123) to charge the user, and provide the set of discrete price points (521) as a response to the third request (503).

In one embodiment, the amount (517) is according to the set of discrete price points (503); and the interchange (101) transmits one or more premium messages of discrete prices to the telephonic apparatus (e.g., the mobile phone (117)) at the phone number (123). In one embodiment, the one or more premium messages are transmitted via a short message service (SMS), or a multimedia message service (MMS).

In one embodiment, the interchange (101) is configured to use the API (501) to receive a request for a list of funding sources associated with the phone number (123); and the interchange (101) is to provide the list of identifiers corresponding to the funding sources respectively as a response.

In one embodiment, the first request further specifies one identifier from the list of identifiers; and the charging the user is to use a funding source identified by the identifier. The list of identifiers may be named by the user of the phone number (123) and stored in the data storage facility (107) of the interchange (101). The funding sources may be one or more of: a credit card account, a debit card account, a bank account, and an account with a payment intermediary service.

In one embodiment, the first request (505) further identifies a uniform resource identifier (URI); and the interchange (101) is configured to visit the URI specified in the first request (505) upon successfully charging the user according to the amount (517) specified in the first request (505).

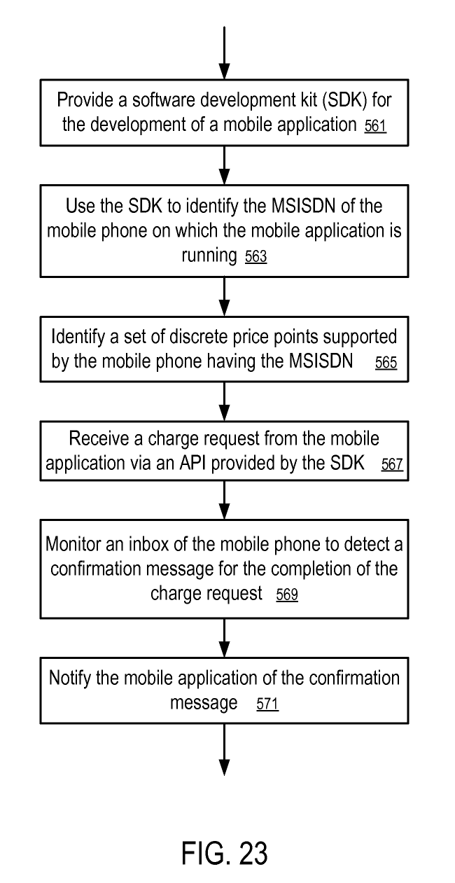

FIG. 23 illustrates a method to process transaction requests in mobile applications according to one embodiment. In FIG. 23, a software development kit (SDK) (539) is provided (561) for the development of a mobile application (541). The SDK (539) may be provided to a developer via a website, or using a removable computer storage media, such as a Compact Disk Read-Only Memory (CD ROM), Digital Versatile Disk (DVD), flash drive, etc.

In one embodiment, a mobile application can use (563) the SDK (539) to identify the MSISDN (535) of the mobile phone (117) on which the mobile application (541) is running The SDK (539) is configured to identify (565) a set of discrete price points (521) supported by the mobile phone (117) having the MSISDN (535). After the SDK (539) receives (567) a charge request from the mobile application (541) via an API (537) provided by the SDK (539), the SDK (539) submits the request to the interchange (101) (e.g., via the API (501)), using a Hypertext Transfer Protocol (HTTP) request or a short message service (SMS) message (or an MMS message, or one or more mobile initiated premium messages).

In one embodiment, the SDK (539) is configured to monitor (569) an inbox (533) of the mobile phone (117) to detect a confirmation message for the completion of the charge request and to notify (571) the mobile application (541) of the confirmation message detected in the inbox (533).

In one embodiment, the messages in the inbox (533) of the mobile phone (117) are received via a short message service (SMS) and the communication application (531) provided on the mobile phone (117).

In one embodiment, the interchange (101) transmits a mobile terminated premium message to the inbox (533) to indicate the success in fulfilling the charge request; and the charge request is at least partially funded by the mobile terminated premium message delivered to the inbox (533).

In one embodiment, the SDK (539) is also configured to compose mobile messages and instruct the mobile phone (117) to send the mobile messages to the interchange (101). For example, in one embodiment, the SDK (539) instructs the mobile phone (117) to send a premium SMS message to the interchange to provide funds for the payment. In one embodiment, the SDK (539) instruct the mobile phone (117) to send an SMS message to the interchange to confirm a payment request.

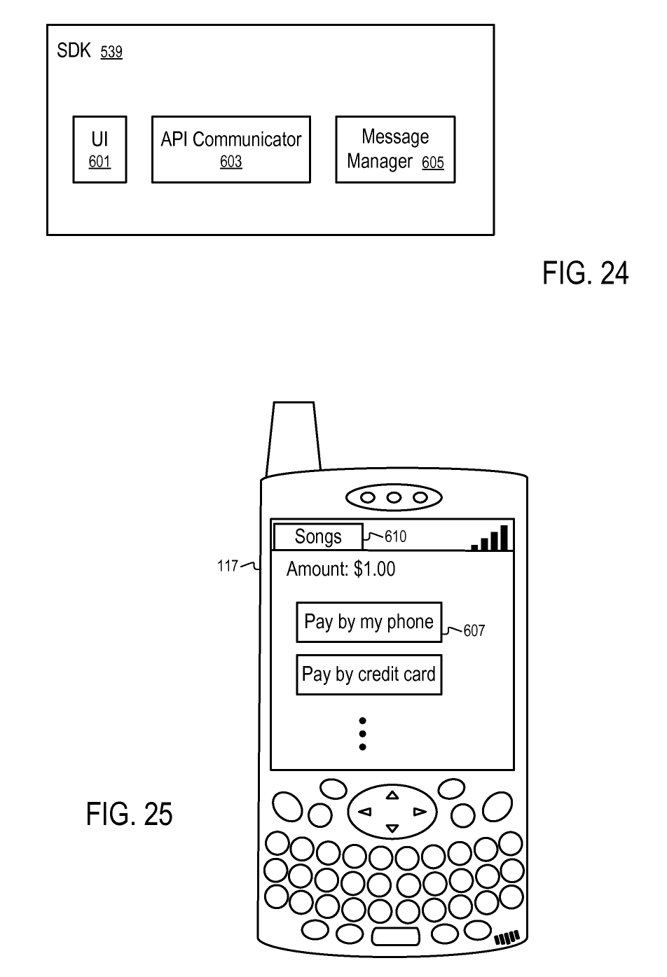

FIG. 24 illustrates an SDK according to one embodiment. In FIG. 24, the SDK (539) includes a number of components, such as a user interface (UI) component (601), an API communicator (603) and a message manager (605).

In one embodiment, the UI component (601) is configured to provide a user interface on the mobile phone (117) to guide the user through the process of making a payment using the interchange (101), as illustrated in FIGS. 25-27. In one embodiment, the UI component (601) is implemented using native code programmed for the operating system of the mobile phone (117). In one embodiment, the UI component (601) is provided via a browser resides on the mobile phone (117); and the interchange (101) provides the content for display in the browser for the UI component (601).

In one embodiment, the API communicator (603) is configured to communicate with the API provided on the interchange (101). In one embodiment, the API communicator (603) is to initiate a payment request via data communications with the interchange (101), such as an HTTP request. The API communicator (603) may communicate with the interchange (101) via various data communication capabilities available in telecommunications systems, such as Internet Protocol based communications, SMS/MMS based communications, email, instant messaging, etc.

In one embodiment, the message manager (605) is used to automate the processing of messages, such as SMS/MMS messages and premium message. For example, in one embodiment, the message manager (605) is to compose an SMS message on behalf of the user for the confirmation of a payment request. In one embodiment, the message manager (605) is to compose a premium SMS message and instruct the mobile phone (117) to transmit the premium SMS message to the interchange (101) to provide the funds for the payment. In one embodiment, the message manager (605) is to monitor the inbox (533) for the confirmation of messages from the interchange (101), such as a premium message transmitted from the interchange (101) to the mobile phone (117) to collect the funds for the payment. Since the message manger (605) automates the processing the messages involved in the payment process, the user does not have to manually use a separate message system to compose the messages and/or to extract information or confirmation. Thus, the user experience is improved.

FIGS. 25-27 illustrate a mobile application using an SDK according to one embodiment. In FIG. 25, a mobile application (541) is illustrated (610) running on the mobile phone (117). The mobile application (541) requests a payment, which can be fulfilled via using the interchange (101).

In one embodiment, when the icon button (607) is selected, the SDK (539) running on the mobile phone (541) communicates with the interchange (101) to process the payment, including transmitting the request to the interchange (101), composing SMS messages on behalf of the user for the confirmation of the payment request, monitoring SMS messages from the interchange (101), etc. In one embodiment, the SDK (539) implements the object represented by the icon button (607) for making payments via the interchange (101).

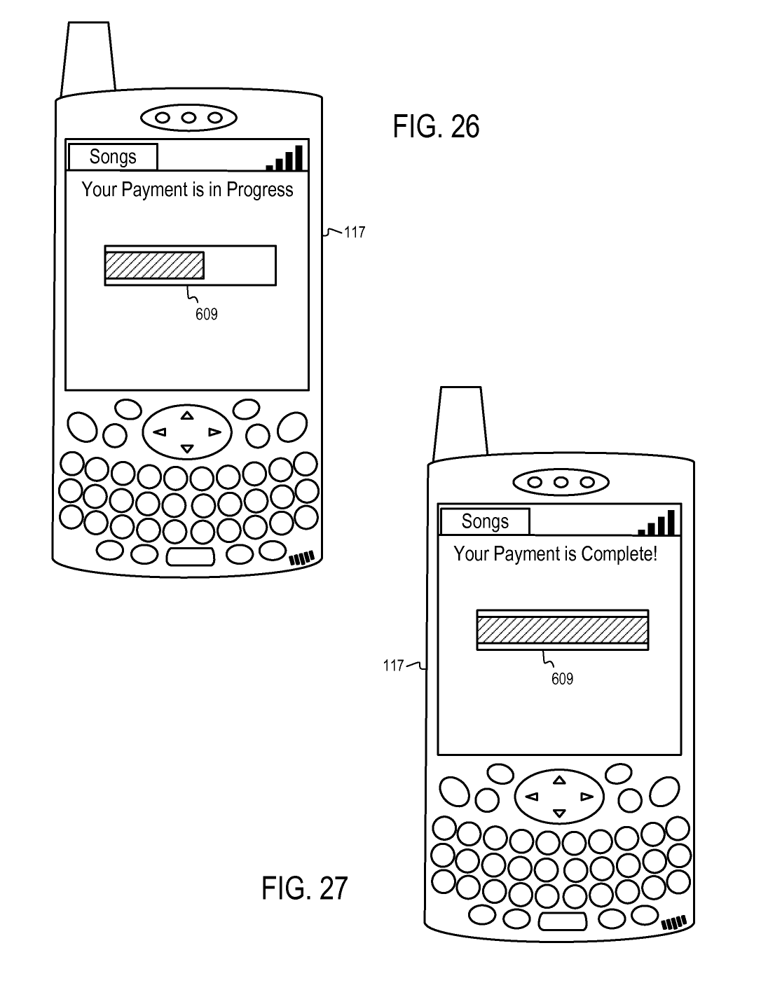

During the process of the payment transaction, the UI component (601) of the SDK (539) presents an indicator, such as the progress bar (609), to indicate the current state of the payment transaction, as illustrated in FIG. 26. In one embodiment, the UI component (601) may use icons and/or text to indicate the current state of the payment transaction, and show an estimated time to the completion of the payment transaction.

FIG. 27 illustrates an example of a user interface to notify the user of the completion of the payment transaction. In one embodiment, the user may click on the notification interface to return to the user interface of the mobile application (541). In one embodiment, the user interface as illustrated in FIG. 27 is automatically closed after a predetermined period of display.

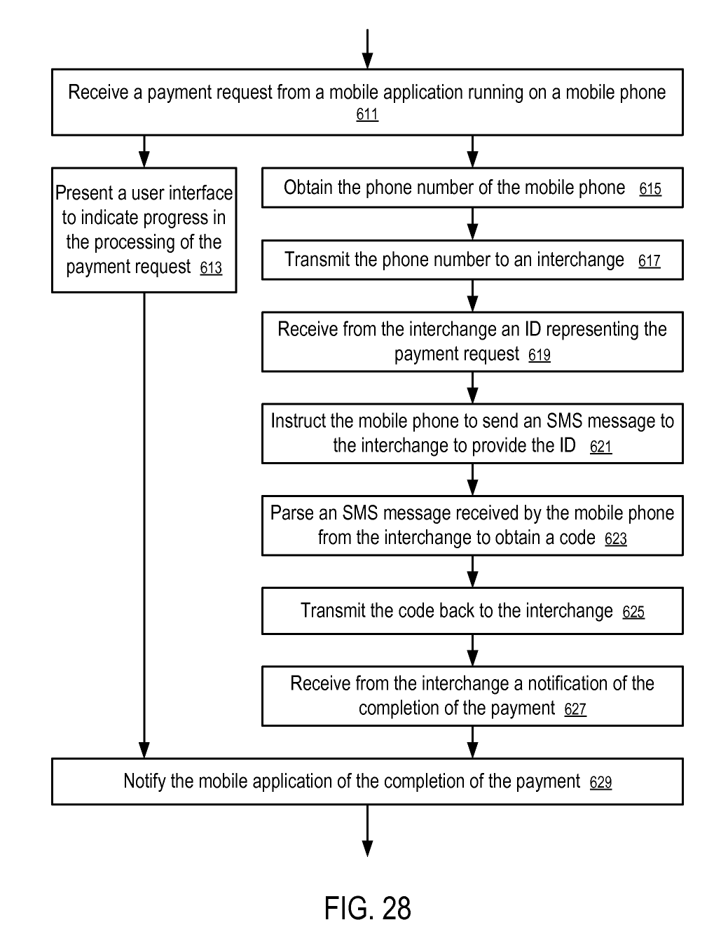

FIG. 28 illustrates a method performed in an SDK according to one embodiment. In FIG. 28, the SDK (539) is configured to receive (611) a payment request from a mobile application (541) running on a mobile phone (117), present (613) a user interface to indicate progress in the processing of the payment request (e.g., as illustrated in FIGS. 26-27), and notify (629) the mobile application (541) of the completion of the payment after the processing of the payment. In one embodiment, the SDK (539) runs on the mobile phone (117) as part of the mobile application (541).

In one embodiment, the SDK (539) is to obtain (615) the phone number (123) (and/or the MSISDN (535)) of the mobile phone (117) and transmit (617) the phone number (123) to an interchange (101) to make the payment request (e.g., via an HTTP request using an API (501) of the interchange (101)). In one embodiment, the UI component (601) is to present the phone number (123) to the user for confirmation, prior to transmitting the payment request. In one embodiment, the payment request includes an identification of the merchant and/or a description of the purchase transaction.

In one embodiment, the SDK (539) is to receive (619) from the interchange (101) an ID representing the payment request. Alternatively, the SDK may generate a unique ID for the payment request and provide the ID to the interchange (101) in the payment request.

In one embodiment, the SDK (539) is to instruct (621) the mobile phone (117) to send an SMS message to the interchange (101) to provide the ID to confirm the payment request and/or to provide funds for the payment.

For example, in one embodiment, the SDK (539) is to compose a premium SMS message, including the ID for the payment request, to provide the funds for the payment. Then the funds for the payment are provided by the SDK (539) via the premium message transmitted from the mobile phone (117), the SDK skips operations (623-625).

In one embodiment, the SDK (539) is to compose a non-premium SMS message, including the ID for the payment request, to confirm the payment request via SMS, after transmitting the payment request via an HTTP request. In response, the interchange (101) is to transmit a premium SMS message to the mobile phone (117) to collect funds for the payment. The SDK (539) is configured to monitor the inbox (533) for the reception of the premium SMS message.

In one embodiment, the premium SMS message includes the ID for the payment request; and the SDK (539) is to check the ID for confirmation. In one embodiment, the premium SMS message includes a delivery report.

In one embodiment, the premium SMS message further includes a code; and the SDK (539) is to parse (623) the SMS message received by the mobile phone from the interchange to obtain the code and to transmit (625) the code back to the interchange (101).

After the code is received back in the interchange (101), the SDK (539) is to receive (627) from the interchange (101) a notification of the completion of the payment.

In some embodiments, the code is transmitted from the interchange (101) via a non-premium message to confirm the identity of the mobile phone (117). In one embodiment, operation (621) is skipped when operations (623-625) are used to confirm the payment request.

In some embodiments, to improve security the SDK (539) may request the user of the mobile phone (117) to provide the PIN (367) for authentication. In one embodiment, the SDK (539) includes the one-time password generator (361) and the uses the one-time password for improved security.

In one embodiment, the SDK (539) allows the user to use other funding sources to support the payments, such as a credit card account, a debit card account, a bank account, a stored value account, a payment intermediary account (e.g., an account identified via an email address), etc. In one embodiment, the SDK (539) is configured to receive and/or maintain the account information (121) representing the funding sources on the mobile phone (117) for the user; and the account information (121) is transmitted to the interchange (101) when needed to provide funds for a payment. In one embodiment, the account information (121) is stored in the data storage facility (107) of the interchange (101); the SDK (539) is to receive a list of payment options, as supported by the account information (121) for the phone number (123), from the interchange (101); and the payment options are presented by the UI component (601) without revealing the account information (121).

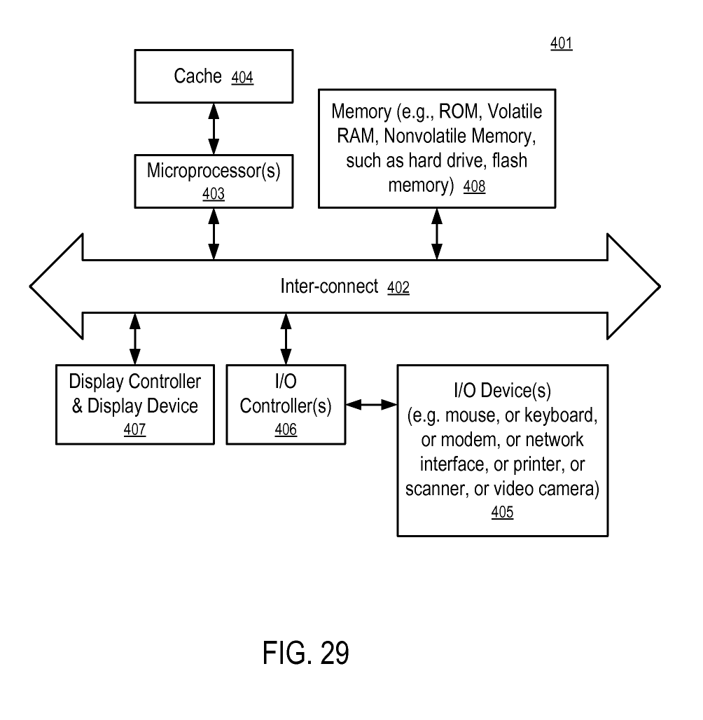

FIG. 29 shows a data processing system, which can be used in various embodiments. While FIG. 29 illustrates various components of a computer system, it is not intended to represent any particular architecture or manner of interconnecting the components. Some embodiments may use other systems that have fewer or more components than those shown in FIG. 29.

In one embodiment, each of the interchange (101), the data storage facility (107), the controllers (115), the mobile phones (117), the user terminals (111), the account server (125) and the servers (113) can be implemented as a data processing system, with fewer or more components, as illustrated in FIG. 29.

In FIG. 29, the data processing system (401) includes an inter-connect (402) (e.g., bus and system core logic), which interconnects a microprocessor(s) (403) and memory (408). The microprocessor (403) is coupled to cache memory (404) in the example of FIG. 29.

The inter-connect (402) interconnects the microprocessor(s) (403) and the memory (408) together and also interconnects them to a display controller, display device (407), and to peripheral devices such as input/output (I/O) devices (405) through an input/output controller(s) (406).

Typical I/O devices include mice, keyboards, modems, network interfaces, printers, scanners, video cameras and other devices which are well known in the art. In some embodiments, when the data processing system is a server system, some of the I/O devices, such as printer, scanner, mice, and/or keyboards, are optional.

The inter-connect (402) may include one or more buses connected to one another through various bridges, controllers and/or adapters. In one embodiment, the I/O controller (406) includes a USB (Universal Serial Bus) adapter for controlling USB peripherals, and/or an IEEE-1394 bus adapter for controlling IEEE-1394 peripherals.

The memory (408) may include ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, various functions and operations may be described as being performed by or caused by software code to simplify description. However, those skilled in the art will recognize that what is meant by such expressions is that the functions result from execution of the code/instructions by a processor, such as a microprocessor. Alternatively, or in combination, the functions and operations can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a tangible machine readable medium includes any apparatus that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method, comprising:
providing a computing device configured with an application programming interface;
receiving requests using the computing device through the application programming interface, the requests comprising
a first request having an identification of a phone number, an identification of a merchant, and an amount, and
a second request having an identification of the first request;
transmitting a message from the computing device to a telephonic apparatus at the phone number to confirm the first request;
after the first request is confirmed via communicating with the telephonic apparatus at the phone number, charging the user of the phone number according to the amount specified in the first request; and
providing a status of the first request in response to the second request, in accordance with the application programming interface.

2. The method of claim 1, further comprising:
providing the identification of the first request as a response to the first request in accordance with the application programming interface.

3. The method of claim 1, wherein the application programming interface is implemented via a web service.

4. The method of claim 1, wherein the requests further comprise a third request having the phone number; and the method further comprises:
identifying a mobile carrier of the phone number in response to the third request;
determining a set of discrete price points supported by the mobile carrier, wherein the user of the phone number is chargeable via the mobile carrier at the set of discrete price points; and
providing the set of discrete price points as a response to the third request.

5. The method of claim 4, wherein the amount is according to the set of discrete price points; and the charging the user comprises transmitting one or more premium messages of discrete prices to the telephonic apparatus at the phone number.

6. The method of claim 5, wherein the one or more premium messages are transmitted via a short message service (SMS).

7. The method of claim 1, wherein the requests further comprise a third request having the phone number; and the method further comprises:
determining a list of funding sources associated with the phone number; and
providing a list of identifiers corresponding to the list of funding sources respectively as a response to the third request.

8. The method of claim 7, wherein the first request further specifies one identifier from the list of identifiers; and the charging the user is to use a funding source identified by the identifier.

9. The method of claim 8, wherein the list of identifiers are named by the user of the phone number.

10. The method of claim 8, wherein the funding source is one of: a credit card account, a debit card account, a bank account, and an account with a payment intermediary service.

11. The method of claim 1, wherein the first request further identifies a uniform resource identifier (URI); and the method further comprises:
upon successfully charging the user according to the amount specified in the first request, visiting the URI specified in the first request.

12. A method, comprising:
providing a software development kit to a developer of a mobile application, the software development kit including a set of instructions to be included as part of the mobile application, when executed on a mobile phone the set of instructions to cause the mobile phone to:
identify a Mobile Subscriber Integrated Services Digital Network Number (MSISDN) of the mobile phone,
communicate with a remote server to determine a set of discrete price points supported by a mobile carrier of the mobile phone, wherein the user of the phone number is chargeable via the mobile carrier at the set of discrete price points,
provide the set of discrete price points to the mobile application,
receive a charge request from the mobile application in accordance with an application programming interface provided by the software development kit, the charge request being based on the set of discrete price points,
communicate the charge request to the remote server,
monitor an inbox of the mobile phone for a message from the remote server indicating a success in fulfilling the charge request, and
notify the mobile application of the success in accordance with the application programming interface.

13. The method of claim 12, wherein the messages in the inbox of the mobile phone are received via a short message service (SMS).

14. The method of claim 13, wherein the charge request is communicated to the remote server via a Hypertext Transfer Protocol (HTTP) request; and the set of instructions is to further cause the mobile phone to receive an identification to represent the charge request and to transmit an SMS message including the identification to confirm the charge request.

15. The method of claim 13, wherein the charge request is communicated to the remote server via the short message service (SMS).

16. The method of claim 13, wherein the message from the remote server indicating the success in fulfilling the charge request comprises a mobile terminated premium message; and the charge request is at least partially funded by the mobile terminated premium message.

17. The method of claim 12, wherein the charge request is communicated to the remote server via one or more mobile initiated premium messages.

18. The method of claim 12, wherein the set of instructions are further configured to cause the mobile phone to encrypt the charge request using a public key associated with a merchant of the mobile application.

19. The method of claim 18, wherein the charge request comprises an identification of the merchant, an amount specified according to one or more of the discrete price points, and the MSISDN.

20. A system, comprising:
a data storage facility to store data associating phone numbers with accounts;
an interchange coupled with the data storage facility, the interchange including a common format processor and a plurality of converters to interface with a plurality of controllers of mobile communications, the converters configured to communicate with the controllers in different formats, the converters to communicate with the common format processor in a common format, the common format processor configured with an application programming interface to receive requests via Hypertext Transfer Protocol, the requests including
a first request having an identification of a phone number, an identification of a merchant, and an amount, and
a second request having an identification of the first request,
wherein the common format processor is to use one converter of the converters to transmit a message to a telephonic apparatus at the phone number to confirm the first request;
wherein after the first request is confirmed via communicating with the telephonic apparatus at the phone number, the common format processor is to charge the user of the phone number according to the amount specified in the first request; and
wherein the common format processor is to provide a status of the first request in response to the second request, in accordance with the application programming interface.
